(19) United States
(12) Patent Application Publication
(10) Pub. No.: US 2026/0079807 A1
(43) Pub. Date: Mar. 19, 2026

(54) SYSTEM AND METHOD FOR CONTEXTUAL QUALITY OF SERVICE MONITORING FOR EXECUTION OF MACHINE LEARNING MODEL ALGORITHMS EXECUTING ON AN INFORMATION HANDLING SYSTEM

(71) Applicant: Dell Products LP, Round Rock, TX (US)

(72) Inventors: Srikanth Kondapi, Austin, TX (US); Jacob Mink, Cedar Park, TX (US)

(73) Assignee: Dell Products LP, Round Rock, TX (US)

(21) Appl. No.: 18/886,516

(22) Filed: Sep. 16, 2024

(51) Int. Cl. G06F 11/34; G06F 11/30

(52) U.S. Cl. CPC G06F 11/3409; G06F 11/3062

(57) ABSTRACT

An information handling system includes a hardware processor executing computer-readable program code instructions of artificial intelligence (AI) productivity tool software module to identify a capability intent action associated with one or more AI productivity tool-enablable software applications via invocation of a first size-variant machine learning (ML) model algorithm to identify the capability intent action based on user-query input, and executing code instructions of a workload orchestrator to monitor execution of the first size-variant ML model algorithm for an identified operation to determine when to switch to execution to a second size-variant ML model algorithm or switch to a different hardware processor to execute the identified operation to maintain a quality of service (QoS) metric threshold for operation of the information handling system as well as precision of output for the size-variant ML model algorithm used.

### FIELD OF THE DISCLOSURE

The present disclosure generally relates to execution of computer-readable program code instructions of an AI productivity tool software module with one or more machine learning (ML) model algorithms to identify a capability associated with the execution of an artificial intelligence (AI) productivity tool-enablable software application responsive to user-query inputs. The present disclosure more specifically relates systems and methods of executing computer-readable program code instructions for the one or more ML model algorithms in light of contextual quality of service (QoS) metrics to identify a capability associated with the execution of an AI productivity tool-enablable software application responsive to user-query inputs.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workplace productivity applications or other application such as for teleconferencing, word processing, sales systems, business software, gaming applications, or the like. Further, the information handling system may include an on the box (OTB) artificial intelligence (AI) productivity tool software module employing machine learning (ML) models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that includes computer-readable program code instructions of an AI productivity tool software module to select among a plurality of machine learning (ML) module algorithms to determine AI productivity tool-enablable software applications having responsive software services, operations, or other capabilities as controlled based on contextual quality of service (QoS) metrics according to an embodiment of the present disclosure;

FIG. 2 is a graphic and block diagram illustrating an information handling system that includes computer-readable program code instructions of an AI productivity tool subagent to select among a plurality of available ML model algorithms to determine AI productivity tool-enablable software applications having responsive software services, operations, or other capabilities as controlled based on contextual quality of service (QoS) metrics according to an embodiment of the present disclosure; and

FIG. 3 is a flow diagram showing a method of executing computer-readable code instructions of a workload orchestrator for an AI productivity tool subagent implementing contextual quality of service (QoS) machine learning model algorithm selection in an information handling system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tool software applications to optimize user productivity and performance of the information handling systems. Examples of such artificial intelligence methodologies includes chatbots to simulate conversations between the information handling system and the user. In an example embodiment of the present disclosure, an AI productivity tool software module may be used to trigger changes in firmware or hardware (e.g., changing display or power settings), software, or processes of one or more AI productivity tool-enablable software applications (e.g., send an e-mail or text message, schedule a meeting). Various machine learning models may be used to support such functionality, including automatic speech recognition (ASR) models, text embedding models, and similarity search models that may work in combination with one another to identify a capability intent action that may be taken by an AI productivity tool-enablable software applications as requested within a received user-query input according to embodiments herein. For example, an AI productivity tool software module and an operatively-coupled AI productivity tool subagent may be capable of determining a user's intent for correlation to a capability intent action that is responsive to a user-query input. The AI productivity tool software module and subagent matches a determined query intent with a capability intent known to be achievable, based on published or established capabilities by a particular of one or more AI productivity tool-enablable software applications executing at the information handling system. In some examples, once the AI productivity tool-enablable software application capable of performing the user-requested capability intent action within the user-query input is identified, the AI productivity tool subagent may identify an application programming interface (API) call that, when executed, may cause the AI productivity tool-enablable software application associated with the identified capability to perform that identified, responsive capability.

As described, however, while the AI productivity tool subagent is identifying the AI productivity tool-enablable software application that can provide the capability intent action identified from the user-query input, an intent identification software application may invoke execution of computer readable code instructions of one or more ML model algorithms in order to identify the query intent value and appropriate AI productivity tool-enablable software application that can perform the responsive capability intent action. These ML model algorithms may consume a significant amount of system resources from a hardware processor, for example, and may also impact performance at the information handling system. This is despite instances where the ML model algorithms available for use with this AI productivity tool subagent may be one of many variants of ML model algorithms that include “small” ML model algorithm variants, “default” ML model algorithm variants, or “large” ML model algorithm variants each of which may have benefits or drawbacks of accuracy, speed, and processing consumption.

The present specification describes systems and methods of implementing contextual quality of service (QoS) machine learning model algorithm selection in an information handling system. The system and method may include a hardware processor to execute computer-readable program code instructions of an intent identification software application to identify a responsive capability intent action, responsive to a user-query input, to execute that is associated with one or more AI productivity tool-enablable software applications. In an embodiment, the intent identification software application may invoke one of a plurality of available size-variant ML model algorithms that may be executed to identify the capability intent action based on the user-query input. As described herein, the size of these plurality of available size-variant ML model algorithms may include various bit sizes of ML model algorithms with various quantizations of input and processing levels or recursions. Such various sized ML model algorithms may increase or reduce the static memory storage requirements and any available ML model algorithm execution provider hardware processing resources within the information handling system needed for respective ML model algorithm execution. In an embodiment, the plurality of size-variant ML model algorithms may include a disparate number of parameters and bit sizes with each of the size-variant ML model algorithms but may also yield disparate precision to identify the capability intent action as well as tradeoffs in required processing or memory levels or processing time and responsiveness.

In an embodiment, the systems and methods further include computer-readable program code instructions of a system state component discovery software application to, when executed by a hardware processor, identify an ML model algorithm execution provider hardware processing resource that is capable of executing the invoked one of the plurality of size-variant ML model algorithms used to identify the capability intent action. The system state component discovery software application gathers runtime telemetry data describing a current operating environment within the information handling system as the identified (e.g., one or more selected ML model algorithm execution provider hardware processing resources) executes the invoked one of the plurality of size-variant ML model algorithms to determine baselines or monitor ongoing execution of the size-variant ML model algorithm. Further, the system state component discovery software application gathers runtime telemetry data describing a current operating environment within the information handling system in anticipation of execution by one or more selected ML model algorithm execution provider hardware processing resources of one of the plurality of size-variant ML model algorithms to determine selection among the size-variant ML model algorithms. A plurality of available size-variant ML model algorithms may be a grouped set available for execution to support an identified productivity-tool operation similar or common to the grouped size-variant ML model algorithms according to embodiments herein.

In the context of the present specification, the ML model algorithm execution provider hardware processing resource may be one or a combination of ML model algorithm execution provider hardware processing resources such as a central processing unit (CPU), an embedded controller (EC), a graphics processing unit (GPU), a neural processing unit (NPU), and an audio processing unit (APU), or the like. Some of these hardware processing devices may not be included “on-the-box” of the information handling system in some embodiments and the execution of the computer-readable program code of the system state component discovery software application may identify the availability of these hardware devices. The runtime telemetry data may be obtained while the one model algorithm execution provider (e.g., a hardware processor) is executing computer-readable program code of the intent identification software application used to identify the capability intent action associated with one or more AI productivity tool-enablable software applications based on the user-query input.

In an embodiment, the systems and methods may also include execution of computer-readable program code instructions of a workload orchestrator used to, when executed by a hardware processor, receive data describing the gathered runtime telemetry from the system state component discovery software application and monitor the identified ML model algorithm execution provider hardware processing resource. This monitoring of the identified ML model algorithm execution provider hardware processor occurs during executing the invoked one or more size-variant ML model algorithms to determine when the execution of the one or more size-variant ML model algorithms by the identified ML model algorithm execution provider hardware processing resource meets a quality of service (QoS) metric threshold used to optimize the operating environment within the information handling system. In an embodiment, based on the detected QoS metrics, the type of size-variant ML model algorithm and/or the ML model algorithm execution provider hardware processing resource selected may be changed in order to improve a QoS metric value relative to the QoS metric threshold.

In an embodiment, the hardware processor may execute the computer readable program code of the workload orchestrator to determine a confidence score associated with the execution of each of the plurality of available size-variant ML model algorithms via the ML model algorithm execution provider hardware processing resource and, when the confidence score does not meet a threshold confidence score, the workload orchestrator signals the intent identification software application to select a second size-variant ML model algorithm among the plurality of available size-variant ML model algorithms to execute any portion of the process to identify the capability intent action responsive to a user-query input.

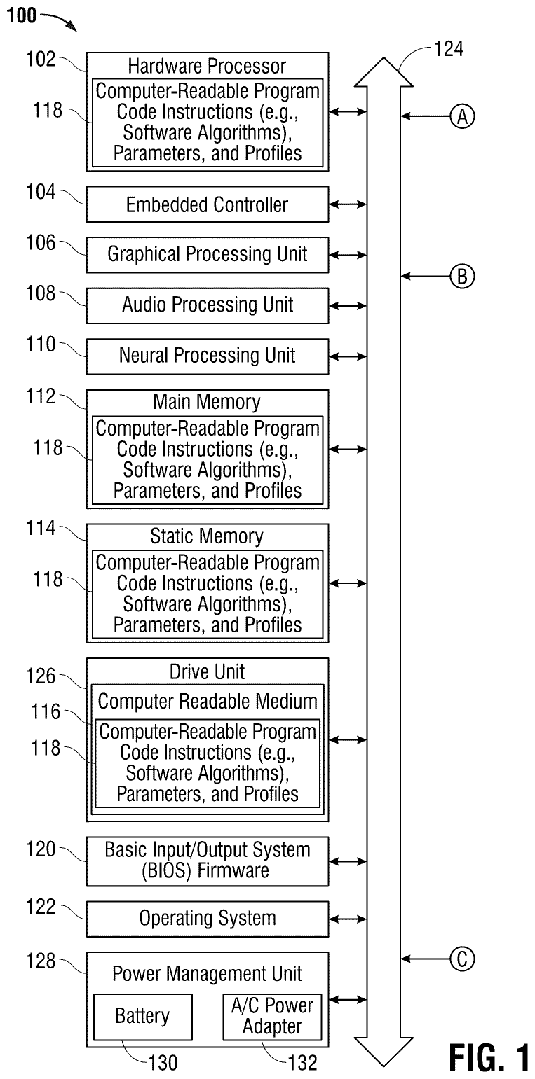

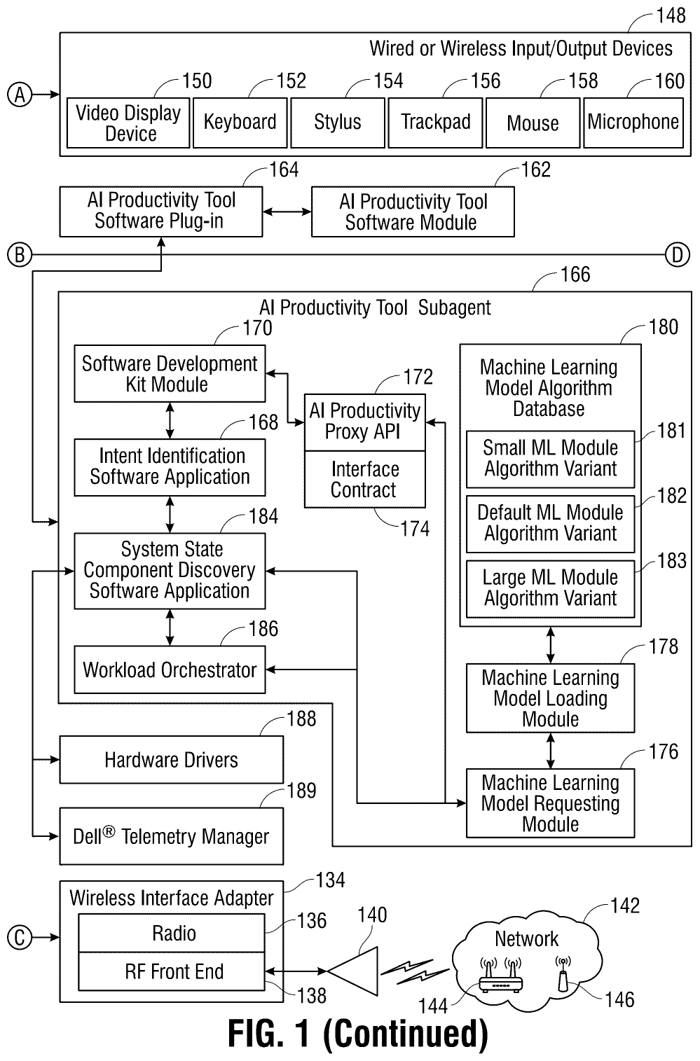

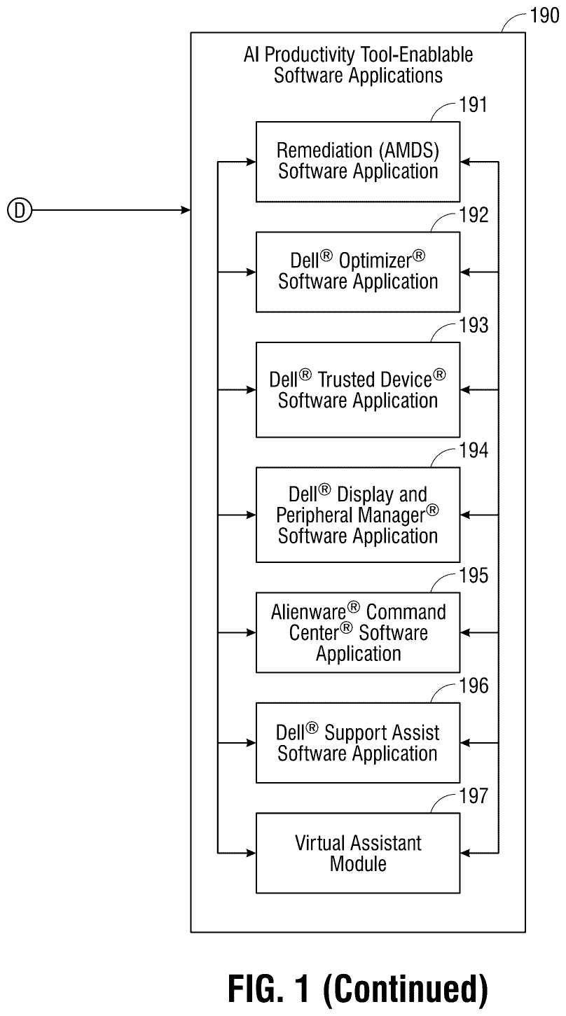

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify capability intent actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 (e.g., central processing unit (CPU)), an embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be quickly accessible by hardware processing resources using that main memory 112. Computer-readable program code instructions stored in static memory 114, main memory 112, or drive unit 126 may involve some latency in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various input and output (I/O) devices 148, such as a mouse 158, a trackpad 156, a stylus 154, a keyboard 152, a video/graphics display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 118 that may operate on servers or systems, remote data centers, or on-box in individual client information handling systems according to various embodiments herein. In some embodiments, it is understood any or all portions of instructions (e.g., software algorithms), parameters, and profiles 118 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing instructions (e.g., software algorithms), parameters, and profiles 118 executable by the hardware processor 102 (e.g., central processing unit), NPU, APU, EC 104, GPU 106, or any other hardware processing device. The information handling system 100 may also include one or more buses 124 operable to transmit communications between the various hardware components such as any combination of various I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU, APU, and/or others may execute one or more bus drivers in order to transmit this data between the information handling system 100 and the input/output devices 148 described herein. In an embodiment, the information handling system 100 may be in wired or wireless communication with the I/O devices 148 such a keyboard 152, a mouse 158, video display device 150, stylus 154, trackpad 156, microphone 160, among other peripheral devices.

As described herein, the information handling system 100 further includes a video/graphics display device 150. The video/graphics display device 150 in an embodiment may function as a liquid crystal display (LCD), an organic light emitting diode (OLED), a flat panel display, or a solid-state display. It is appreciated that the video/graphics display device 150 may be wired or wireless and may be an external video/graphics display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 148, among others that allows the user to interface with the information handling system 100 via the video/graphics display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the I/O devices 148 according to the embodiments described herein. The present specification contemplates that the I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 136 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 140 or base station 142 used to operatively couple the information handling system 100 to a network 142 via a wireless interface adapter 134. In a specific embodiment, the network 142 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 134 may include one or more RF (RF) subsystems (e.g., radio 136) with transmitter/receiver circuitry, modem circuitry, one or more antenna RF (RF) front end circuits 138, one or more wireless controller circuits, amplifiers, antennas 136 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit. Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by any ML model algorithm execution provider hardware processing resource such as a hardware controller or a hardware processor. For purposes of the present specification, the term ML model algorithm is meant to be understood as any machine learning or artificial intelligence (AI) algorithm, including classical AI algorithms, that can be invoked or executed by a hardware processor to receive input data such as user query input data, process that data to provide output at various stages while performing the processes for operations of the AI productivity tool software module to identify and execute a responsive capability intent action as described in embodiments herein. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104 or any other hardware processing resource and may include software agents, or other aspects or components used to execute the methods and systems described herein. Various software modules comprising application computer-readable program code instructions, parameters, and profiles 118 may be coordinated by an OS 122, and/or via an application programming interface (API). An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, or GPU 106, NPU 110, APU 108 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, APU 108, NPU 110, a video/graphic display device 150, or other wired I/O devices 148 such as the mouse 158, the stylus 154, the keyboard 152, the microphone 160, and the trackpad 156 and other components that may require power when a power button has been actuated by a user. In an embodiment, the PMU 128 may monitor power levels and be electrically coupled to the information handling system 100 to provide this power. The PMU 128 may be coupled to the bus 124 to provide or receive data or machine-readable code instructions. The PMU 128 may regulate power from a power source such as the battery 130 or AC power adapter 132. In an embodiment, the battery 130 may be charged via the AC power adapter 132 and provide power to the components of the information handling system 100, via wired connections as applicable, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory such as main memory 112 or other volatile re-writable memory such as static memory 114. Additionally, the computer-readable medium can include a magneto-optical or optical medium, such as a disk or tapes or other storage device drive unit 126 to store information received via carrier wave signals such as a signal communicated over a transmission medium. Furthermore, a computer readable medium 114 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments herein, the information handling system 100 includes an AI productivity tool software module 162 and an AI productivity tool software plug-in 164 to receive user-query input and provide that user-query input to the AI productivity tool subagent 166. In an embodiment, the execution of the computer-readable program code instructions 118 of the AI productivity tool subagent 166 by the hardware processor 102 or any other hardware processing device selects among a plurality of available machine learning (ML) model algorithms 181, 182, 183 maintained within a ML model algorithm database 180 for use with execution of a plurality of AI productivity tool-enablable software applications 190 (e.g., 191, 192, 193, 194, 195, 196, 197) according to another embodiment of the present disclosure. As described herein, the computer-readable program code instructions 118 of the AI productivity tool software module 162 and AI productivity tool subagent 162 as well as available machine learning (ML) model algorithms 181, 182, 183 may be executed by a hardware processor 102 or other ML model algorithm execution provider hardware processing resource on the information handling system 100 thereby allowing the methods described herein to be carried out on-the-box such that a wired or wireless network connection to a network is not necessary for operation of the method. In another embodiment, some modules, databases, and/or processing resources such as one or more ML model algorithm variants 181, 182, or 183 may be maintained on a remote server such that a wired or wireless network connection can be made with these remote servers and the method may be implemented as described herein.

The AI productivity software tool module 162 may include any artificial intelligence-based productivity tool to assist in interfacing with and execution of one or more AI productivity tool-enablable software applications 190 and receive inputs from a user and generate responses at an information handling system 100. The AI productivity tool software module 162 may be loaded on-the-box by a manufacturer in software and may include chatbot features, virtual assistant features, and other artificial intelligence features that allow a user to provide input to the information handling system 100 and, with generative artificial intelligence processing of a user input query, execute one or more capabilities that include hardware operations, functions, software services, or responses using one or more AI productivity tool-enablable software applications 190. Examples of some types of AI productivity tool software modules 162 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 100 may include any proprietary AI productivity tool software module 162 installed by an information handling system 100 manufacturer and used to interface with the information handling system 100 and the operations thereon. In various embodiments, the hardware processor 102 or other alternative hardware processing resources of the information handling system 100 may execute computer-readable program code instructions of the AI productivity tool software module 162 with its AI productivity tool plug-in 164 and monitor for user input for a user query at a microphone 156, keyboard 152, or other input device for the AI productivity tool subagent 166 to engage in determining capability intent actions responsive to the user-query input.

The AI productivity tool software module 162, executing on the hardware processor 102, such as a CPU, or other hardware processing resource (e.g., EC 104, GPU 106, APU 108, or NPU 110), may interface with other hardware components and with the AI productivity tool-enablable software applications 190 as well as one or more ML model algorithms 181, 182, 183 via an AI productivity tool plug-in 164. The AI productivity tool plug-in 164 may be any software or firmware that allows the AI productivity tool subagent 166 to perform those actions responsive to a user-query input at the information handling system 100 based on user-query input (e.g., typed, spoken words, images, etc.) provided from the user. The AI productivity tool plug-in 164 may be used by the AI productivity tool software module 162 and AI productivity tool subagent 166 to interface with any number of AI productivity tool-enablable software applications 190 executing or executable on the information handling system 100 according to embodiments herein.

Again, the information handling system 100 also includes the AI productivity tool subagent 166 associated with the AI productivity tool software module 162. The AI productivity tool subagent 166 may be any software and/or firmware executable by the hardware processor 102 or other ML model algorithm execution provider hardware processing resources 104, 106, 108, 110 of the information handling system 100 to interface with one or more of the plurality of the AI productivity tool-enablable software applications 190 to provide AI enabled capabilities within those AI productivity tool-enablable software applications (e.g., 190, 191, 192, 193, 194, 195, 196, 197) for responsive hardware, firmware, or software operations, functions, software services, or responses to user input queries. Examples of AI productivity tool-enablable software applications 190 include a remediation (AMDS) software application 191, Dell® Optimizer® software application 192, Dell® Trusted Device® software application 193, Dell® Display and Peripheral Manager® software application 194, Alienware® Command Center® (AWCC) software application 195, Dell® Support Assist® software application 196, and a virtual assistant module 197. In an embodiment, the computer-readable program code instructions of the AI productivity tool-enablable software applications 190 and modules described herein (e.g., 190, 191, 192, 193, 194, 195, 196, 197) may operate wholly “on-box” within the information handling system 100 or be sub-agents on-box for interfacing with remote software systems executing at remote server locations. In an embodiment, the AI productivity tool subagent 166 may be used to direct the execution of various modules in support of one or more identified productivity tool operations the AI productivity tool-enablable software applications 190 and AI productivity tool software module 162 described herein. Additionally, the AI productivity tool subagent 166 may be provided with access to the BIOS and OS of the information handling system 100. Example of identified productivity tool operations include execution of code instructions of the AI productivity tool software module 162 to determine user-query intent values, match these with generated capability intents, and to execute code instructions of one of the AI productivity tool-enablable software applications 190 to conduct the capability intent actions pursuant to the user's query input.

In an embodiment, during operation, the hardware processor 102 or other hardware processing resource (e.g., EC 104, GPU 106, CPU, APU 108, or NPU 110) executes computer-readable program code instructions of the AI productivity tool subagent 166 that includes an intent identification software application 168. The intent identification software application 168 may engage with a machine learning model requesting module 176 to have one or more ML model algorithms 181, 182 183 loaded and executed on the hardware processor in order to, initially, determine the query intent value of a user-query input and to correlate it with a capability intent action to be conducted responsive to the received user-query inputs. The execution of the computer-readable program code instructions of the intent identification software application 164 may call a software development kit (SDK) module 170. The SDK module 170 may include any computer-readable program code instructions that is executed by the hardware processor 102 or other hardware processing resource to request that a ML model algorithm 181, 182, 183 that may be of differing size variants and invoked to support an identification of, in an embodiment, a capability intent action based on received user-query inputs from a user.

For example, the ML model algorithm 181, 182, 183 may include one or more size variants of a query input-to-intent ML model algorithm that receives the user-query input, and with an embedding algorithm generates a vectorized query intent value for the user-query input for later correlation with a capability intent value. In the embodiments herein, the ML model algorithm 181, 182, 183 may include a small ML model algorithm variant 181, a default ML model algorithm variant 182, and a large ML model algorithm variant 183 each grouped together as size-variant ML model algorithms of a similar ML model algorithm identified with a similar or common productivity tool operation (e.g., variants of the query input-to-intent ML model algorithm). For example, the small ML model algorithm variant 181 may be a “small” variant of the query input-to-intent ML model algorithm. In another example, the default ML model algorithm variant 182 may be a “default” sized variant query input-to-intent ML model algorithm. Still further in this example, the large ML model algorithm variant 183 may be a “large” variant of the query input-to-intent ML model algorithm. Each of these size variants of the ML model algorithm (e.g., 181, 182, and 183) may include disparate number of parameters and bit sizes with each of the plurality of available size-variant ML model algorithms of a similar type for a given identified AI productivity-tool operation and which may yield different levels of precision to, in an embodiment, execute the identified AI productivity-tool operation. For example, the size variants of the ML model algorithms (e.g., 181, 182, and 183) may include disparate number of parameters and bit sizes in support of each identified common AI productivity-tool operation for each of the steps for identifying a responsive capability intent action based on the user-query input received at the AI productivity tool software module 162 from the user. These differing size-variant ML model algorithms 181, 182, 183 of a similar function will have trade-offs between precision of the outputs and ML model algorithm execution provider hardware processing resources consumed or latency of operation among other factors in embodiments herein. It is appreciated that each type of the ML model algorithms stored within the ML model algorithm database 180 are grouped for a similar or common productivity tool operation identified for operation with the AI productivity tool software module 162 or one of the AI productivity tool-enablable software applications 190. The types of identified AI productivity-tool operations may have one or more size-variants available such that any given ML model algorithm could include a “small,” “default,” and “large” variant for execution by the hardware processor 102 (e.g., CPU) or other processing device 104, 106, 108, 110 in order for one or more of AI productivity tool-enablable software applications 190 to perform software services, operations, or responses based on the user-query input.

In an example embodiment, one identified type of the ML model algorithms associated with an identified common AI productivity tool operation may also include a query intent-to-capability matching ML model algorithm that includes a small ML model algorithm variant 181 of the query intent-to-capability matching ML model algorithm, a default ML model algorithm variant 182 of the query intent-to-capability matching ML model algorithm, and a large ML model algorithm variant 183 of the query intent-to-capability matching ML model algorithm. Any number of available size-variants of ML model algorithm are contemplated in the present specification. Whichever available ML model algorithm size variant 181, 182, 183 receives the vectorized query intent value as input, executes the selected size-variant ML model algorithm then matches the vectorized query intent value to a vectorized capability intent value associated with the AI productivity tool-enablable software application 190 via a similarity correlation algorithm for lexical or semantic matching to identify a responsive capability that can serve as the capability intent action responsive to a user-query input. The selected size variant ML model algorithm for the query intent-to-capability matching ML model algorithm may yield disparate levels of precision for output but may also differ in levels of memory and hardware processing resources consumed as well as latency or other aspects affecting QoS of response.

It is appreciated that the selected ML model algorithm variant 181, 182, 183 for a similar or common identified AI productivity-tool operation type may satisfy an interface contract 174 requested by the intent identification software application 168 such that the query intent value from the user-query inputs may be interpreted and an available capability associated with one of the plurality of AI productivity tool-enablable software applications 190 as the capability intent action can be matched to the user's query input. The interface contract 174 described herein defines the requirements that selected ML model algorithm variants from among an available plurality of ML model algorithms 181, 182, 183 are to have in order to be able receive a specific type of input from the AI productivity tool software module 162, the intent identification software application 168 or any AI productivity tool-enablable software application 190 and to provide a specific type of output to the AI productivity tool software module 162, the intent identification software application 168 and/or AI productivity tool-enablable software applications 190. In an embodiment, the interface contract 174 is generated by an AI productivity proxy API 172 invoked by the SDK module 170 in order to identify the similar or common productivity-tool operation type ML model algorithm and the selected, specific ML model algorithm variant 181, 182, 183 from among an available plurality of ML model algorithm variants 181, 182, 183 that provides the appropriate output to the intent identification software application 168.

Embodiments of the present disclosure, upon a request for an identified common productivity-tool operation type, a size-variant ML model algorithm is selected from among the plurality of available ML model algorithm variants 181, 182, 183 grouped for that identified common productivity-tool operation type based detected information handling system state and availability of ML model algorithm execution provider hardware processing resources 102, 104, 106, 108, or 110 and availability of other hardware components. The execution of the computer-readable program code of the intent identification software application 168 allows a user to interface with the AI productivity tool software module 162 (e.g., via text, audio, images, etc.) and have a responsive action, such as a hardware operation or adjustment, software service, or other response from the information handling system 100 that satisfies the user's query input.

It is appreciated, that execution of certain size-variant ML model algorithm such as a large ML model algorithm variant 183 may lead to significant system resource consumption such as hardware processing resources thereby creating performance impacts where a specific hardware processor (e.g., 102, 104, 106, 108) is used under certain detected state conditions of the information handling system 100 and its hardware components. In an embodiment, the AI productivity tool subagent 166 includes computer-readable program code instructions 118 of a system state component discovery software application 184 to discover the state of any and all hardware component capabilities via monitored information handling system 100 telemetry as well as any available ML model algorithm execution provider hardware processing resources such as the hardware processor 102, the EC 104, the GPU 106, the APU 108, and the NPU 110 and their levels of processing resource consumption shown in FIG. 1. It is appreciated, that not all of these ML model algorithm execution provider hardware processing resources are available on the information handling system and the execution of the computer-readable program code instructions 118 of the system state component discovery software application 184 identifies whether and to what extent each available hardware processor 102, EC 104, GPU 106, APU 108, NPU 110 is available to execute a size-variant ML model algorithm such as the various small ML model algorithm variants 181, default ML model algorithm variants 182, and large ML model algorithm variants 183 grouped for each of the ML model algorithms for each productivity-tool operation type described herein.

Further, execution of the computer-readable program code instructions 118 of the system state component discovery software application 184 causes runtime telemetry data to be gathered for hardware components as well as for software execution on the information handling system 100. This runtime telemetry data may include data describing a current operating environment within the information handling system 100 while an ML model algorithm execution provider hardware processing resource 102, 104, 106, 108, 110 executes the invoked one or more size-variant ML model algorithms 181, 182, 183. In order to obtain the data related to the available ML model algorithm execution provider hardware processing resources 102, 104, 106, 108, 110 and the runtime telemetry data, the system state component discovery software application 184 may be operatively coupled to any number of hardware drivers 188. The computer-readable program code instructions 118 of the hardware drivers 188 may identity the existence of one or more of the ML model algorithm execution provider hardware processing resources 102, 104, 106, 108, 110 as well as any telemetry data associated with the operation of the ML model algorithm execution provider hardware processing resources 102, 104, 106, 108, 110 such as current consumption of processing resources (for example, peta operations per second (pTops), exa operations per second (eTops), current workloads and usage metrics), RAM occupancy, latency of execution, and other metrics. In some embodiments, additional telemetry data may include individual application usage of ML model algorithms and system resources, thermal effects on, for example, the battery, latencies depending on the location of the ML model algorithms in the topology of the information handling system 100, and energy, estimation, engine (E3) data for carbon impacts by the operations of the information handling system 100. It is appreciated that any other runtime telemetry data may be retrieved while any variant of the ML models are executed or are about to be executed and may be stored for future execution of similar ML model algorithms to anticipate telemetry data changes for selection among available size-variants of an ML model algorithm for a common identified productivity-tool operation. It is also appreciated that any runtime telemetry data may be retrieved using any hardware drivers 188 and may include, for example, a hardware driver associated with the PMU that provides battery relative state-of-charge (RSOC) data (e.g. a range of 0% to 100%). It is appreciated that any other telemetry data may be acquired by the system state component discovery software application 184 via the hardware drivers 188 that would provide additional information related to resource consumptions at the information handling system 100 as the ML model algorithm size variants 181, 182, 183 are being executed by a ML model algorithm execution provider hardware processing resource 102, 104, 106, 108, 110.

In a specific example embodiment, a hardware processing device may execute computer-readable program code instructions 118 of a Dell® Telemetry Manager®. The execution of the computer-readable program code instructions 118 of the Dell® Telemetry Manager® may automatically cause this telemetry data to be retrieved and sent to the system state component discovery software application 184 for processing and use in determining whether a pending execution by an ML model algorithm execution provider hardware processing resource 102, 104, 106, 108, 110 and a selection among a plurality of available size-variant ML model algorithms 181, 182, 183 is appropriate for the current operating conditions detected in the telemetry data gathered by execution of the system state component discovery software application 184.

In an embodiment, a hardware processing device (e.g., 102, 104, 106, 108, 110) may execute computer-readable program code instructions 118 of a workload orchestrator 186 to initially receive the data describing the gathered runtime telemetry data from the system state component discovery software application 184 pending execution of an identified common productivity tool operation type having a plurality of grouped, available size-variant ML model algorithm 181, 182, 183. After receiving this telemetry data, the execution of the computer-readable program code instructions 118 of the workload orchestrator 186 may cause the AI productivity tool subagent 166 to monitor the execution of the selected ML model algorithm variant from among a plurality of available size-variants of available machine learning (ML) model algorithms 181, 182, 183 by the ML model algorithm execution provider hardware processing resource 102, 104, 106, 108, 110 and determine if the execution of the size-variant ML model algorithms 181, 182, 183 by the identified ML model algorithm execution provider hardware processing resource 102, 104, 106, 108, 110 meets a quality of service (QoS) metric threshold used to optimize the operating environment within the information handling system.

It is appreciated that with, for example, the execution of a large ML model algorithm variant 183 of any ML model algorithm for an identified productivity-tool operation type via any given ML model algorithm execution provider hardware processing resource 102, 104, 106, 108, 110, a higher consumption of power and hardware processing resources may be realized relative to the small ML model algorithm variant 181 of that same or common identified productivity-tool operation type of ML model algorithm. However, the precision of the output provided via execution of the small ML model algorithm variant 181 of the common identified productivity-tool operation type of ML model algorithm may be significantly lower than the precision of the output provided via execution of the large ML model algorithm variant 183. In an embodiment, therefore, the workload orchestrator 186 and system state component discovery software application 184 may operate together in order to optimize quantization techniques (e.g., levels of input received and processing levels for recursions, etc.) that includes a focus on selecting the appropriate size-variant ML model algorithm that consumes the least amount of processing resources, the least amount of power, the least amount of memory bandwidth, the lowest latency, and the highest throughput, without losing too much accuracy and precision in the output of the selected or to-be selected size-variant ML model algorithms of an identified common productivity-tool operation type. This selection of size-variant ML model algorithm for precision also maintains balance of a QoS metrics to not exceed or fall below the QoS metric threshold to impact the usage of the information handling system 100 by the user. In an embodiment, the QoS metrics threshold may be set to a specific level of consumption ML model algorithm execution provider hardware processing resources (e.g., >eTops/second) or RAM occupancy above which some or all processes executing on the information handling system 100, including those of AI productivity-tool operations, will be negatively impacted such that the impact may be noticed by a user. In another embodiment, the QoS metrics threshold may be set to a specific level of power consumption (e.g., >40 W/hour) relative to ongoing available battery power.

In an embodiment, the small ML model algorithm variant 181, default ML model algorithm variant 182, and large ML model algorithm variant 183 associated with any given ML model algorithm may each include a disparate number of parameters and bit sizes that identify them as a “small,” “default,” and “large” ML model algorithm variant. In an example, a bit size of a ML model algorithm 181, 182, 183 is defined by the number of parameters and the sizes of the parameters used as input to the ML model algorithm variant that describe the quantization technique of a give size-variant ML model algorithm 181, 182, 183 and may relate to levels of input received, and processing levels or recursions executed. In an example embodiment, a look-up table may be provided that specifically defines each of the small ML model algorithm variant 181, the default ML model algorithm variant 182, and the large ML model algorithm variant 183 based on this criterion. An example look-up table is presented in Table 1 below:

| | Size | | |
|---|---|---|---|
| EP | Large | Medium or “default” | Small |
| CPU | Llama30b-cpu | Llama30b-cpu-int8 | Llama7b-cpu-int8 |
| GPU | Llama30b-gpu | Llama30b-gpu-fp16 | Llama7b-gpu-fp16 |
| NPU | Llama30b-npu | Llama30b-npu-int8 | Llama30b-npu-int4 |
| . . . | . . . | . . . | . . . |

The above table shows a plurality of Llama autoregressive large language models (LLMs) that each may include disparate number of parameters and disparate quantization sizes. For example, Llama7b-gpu-fp16 identifies a Llama autoregressive LLM that has 7 billion parameters, which has been optimized to run on a graphical processing unit (GPU) and has a quantization size of 16 bits. It is appreciated that every type of ML model algorithm may each include its own set of variants that include a large, default or medium, and small variant such that the workload orchestrator may select the appropriate ML model algorithm variant 181, 182, 183 to execute during the identified productivity-tool operations common to those grouped size-variants described herein depending on the state of the hardware components detected at the information handling system 100.

In an embodiment, when the workload orchestrator 186 determines that the execution of a selected size-variant ML model algorithm from among an available plurality of the size-variant ML model algorithms 181, 182, 183 by a selected ML model algorithm execution provider hardware processing resource 102, 104, 106, 108, 110 does not meet the QoS metric threshold, the workload orchestrator 186 may switch to another or second ML model algorithm execution provider hardware processing resource 102, 104, 106, 108, 110 used to execute the selected size-variant ML model algorithm. This change may be due to the system state component discovery software application 184 and workload orchestrator 186 being used to determine that ML model algorithm execution provider hardware processing resource consumption exceeded a QoS metric (e.g., processing resource consumption level) at the previous ML model algorithm execution provider hardware processing resource 102, 104, 106, 108, 110 and, therefore, a different ML model algorithm execution provider hardware processing resource 102, 104, 106, 108, 110 may be used instead. This may occur where, for example, the hardware processor 102 (e.g., CPU) was the originally selected ML model algorithm execution provider hardware processing resource 102, 104, 106, 108, 110 but other processes are or will be executed on the hardware processor 102 and the execution of the selected size-variant ML model algorithms 181, 182, 183 will result in the QoS metric being exceeded or falls below a QoS threshold. In an embodiment, the workload orchestrator 186 may provide instructions to the intent identification software application 168 to switch from the first ML model algorithm execution provider hardware processing resource 102, 104, 106, 108, 110 to the second ML model algorithm execution provider hardware processing resource 102, 104, 106, 108, 110.

In another embodiment, the workload orchestrator 186 may determine that the execution of the selected size-variant ML model algorithm selected from among a plurality of available size-variant ML model algorithms 181, 182, 183 of an identified productivity-tool operation type by the selected ML model algorithm execution provider hardware processing resource 102, 104, 106, 108, 110 does not meet the QoS metric threshold, the workload orchestrator 186 switches the selected size-variant ML model algorithm 181, 182, 183 to another or second size-variant ML model algorithm 181, 182, 183 to be executed on the ML model algorithm execution provider hardware processing resource 102, 104, 106, 108, 110 in an embodiment. The switching from a first selected ML model algorithm 181, 182, 183 to another or second ML model algorithm 181, 182, 183 from among a plurality of available ML model algorithms 181, 182, 183 may be done when the workload orchestrator 186 determines that a QoS metrics threshold has been exceeded or the QoS falls below some threshold and that a lower resolution or accuracy of output from another ML model algorithm 181, 182, 183 (e.g., from a default ML model algorithm variant 182 or a small ML model algorithm variant 181) would be sufficient to complete the identified productivity-tool operation type process described herein. In an embodiment, the workload orchestrator 186 may provide instructions to the intent identification software application 168 to switch from executing the first ML model algorithm 181, 182, 183 to executing the second ML model algorithm 181, 182, 183.

In an embodiment, the workload orchestrator 186 may also engage in a confidence scoring process that calculates a confidence score related to the selection of the execution of any given ML model algorithm 181, 182, 183 by any given ML model algorithm execution provider hardware processing resource 102, 104, 106, 108, 110 relating to precision in executing the identified productivity-tool operation type common to the grouped plurality of available size-variant ML model algorithms 181, 182, 183. In an embodiment, the confidence score may be provided during the execution of the ML model algorithm 181, 182, 183 with the probabilities of each class in the execution of the ML model algorithm 181, 182, 183 that the ML model algorithm 181, 182, 183 is predicting the output from that ML model algorithm 181, 182, or 183 serving as the confidence score. Thus, in those embodiments where the ML model algorithms 181, 182, 183 are probabilistic, the output probability associated with the output of the corresponding ML model algorithm 181, 182, or 183 is used as the confidence score described herein. For example, in an embodiment where neural networks are used, the neural network is trained to provide probability that each class of data output it is predicting (e.g., for correlation) has an accuracy probability which is the confidence score. In another example embodiment, a similarity matching search (e.g., a semantic search) ML model algorithm or other correlation ML model algorithm may serve as the confidence score with the score being 1-cosine_distance (user_input, known_intent) where the cosine_distance is between 0 and 1 such that the more confident values are closer to 0 and values further from zero have a lower probability of accuracy which serves as a confidence score. Thus, a maximum score relative to known_intent values is the overall score used to decide the confidence score in some embodiments.

Thus, if the output from the execution of a specific, selected ML model algorithm 181, 182, 183 for an identified productivity-tool operation type (e.g., embedding an identified query intent value or matching to a capability intent value provided via output from the small variant of the query input-to-intent ML model algorithm) does not have a high confidence score to meet a threshold confidence score (e.g., a percentage probability of accuracy such as 85% or a relative score having a percentage relative to a known correlation being 100%) such that an imprecise determined query intent value or an imprecise lexical or semantic similarity matching to a capability intent is impactful to operations of the AI productivity tool software module 162 on the information handling system 100 as experienced by the user, the user-query input is again run through a relatively larger ML model algorithm 181, 182, 183 (e.g., a default ML model algorithm variant 182 or a large ML model algorithm variant 183 variant of the query intent determination or query intent-to-capability matching ML model algorithm) in order to increase the confidence score for a more precise result in responding to a user query input. This may be done while also working within the constraints of the QoS metric thresholds such that an optimum level of resources are consumed to minimize or not impact other hardware processing on the information handling system 100 while the confidence of the output from the ML model algorithm 181, 182, 183 is sufficient for execution of identified productivity-tool operation for the AI productivity tool software module 162. In an embodiment, the switch between ML model algorithm execution provider hardware processing resources 102, 104, 106, 108, 110 and selected size-variants of ML model algorithms 181, 182, 183 may be completed within a feedback loop process in order to achieve these goals described herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

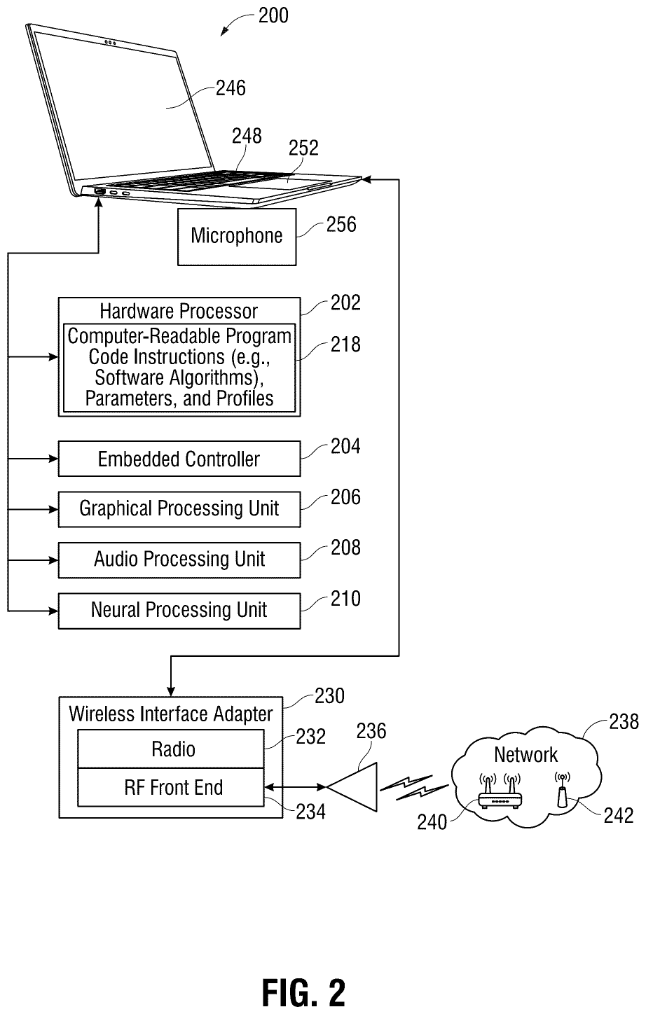

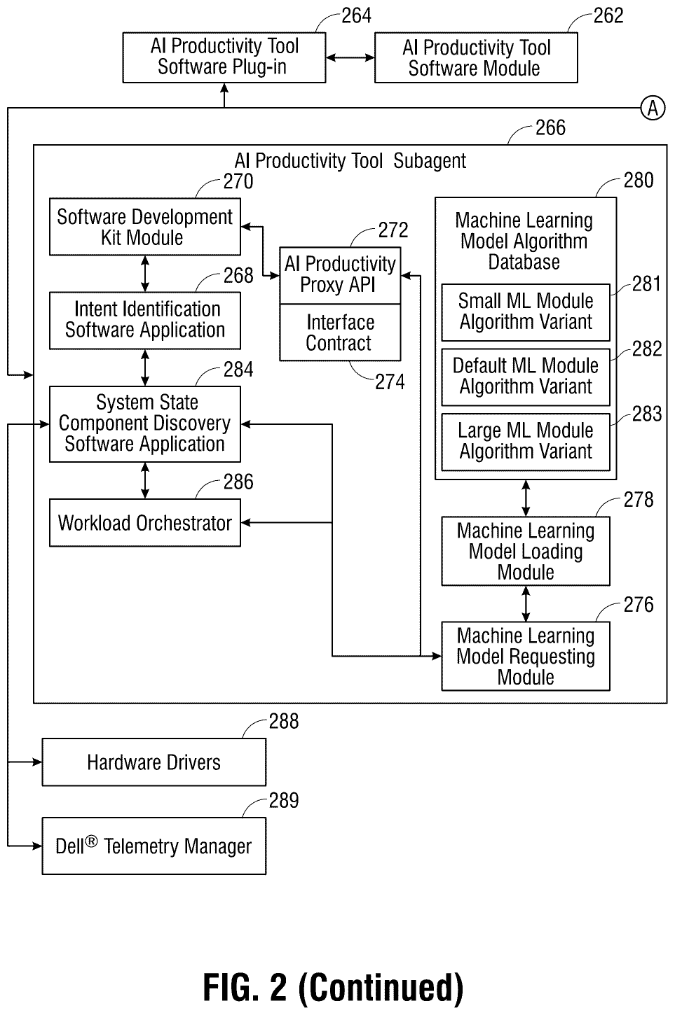

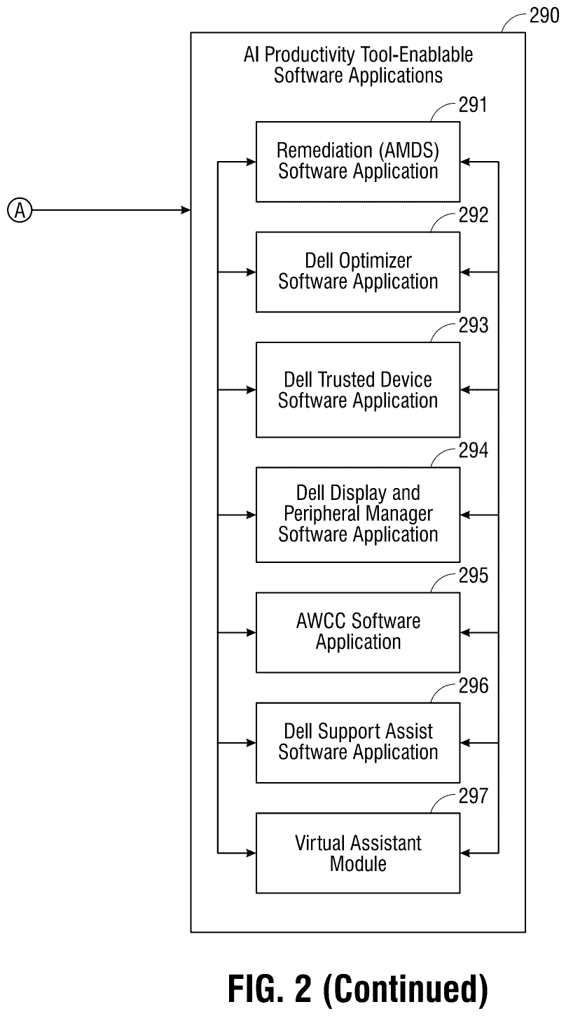

FIG. 2 is a graphic and block diagram illustrating an information handling system 200 that includes computer-readable program code instructions of an AI productivity tool subagent to select among a plurality of AI productivity tool-enablable software applications for software services, operations, or responses responsive to user query inputs using selection from a plurality of available size-variant ML model algorithms as controlled based on contextual quality of service (QoS) metrics according to an embodiment of the present disclosure. As described herein, the information handling system 200 in FIG. 2 is shown as a laptop-type information handling system 200. The information handling system 200 may include a video display device 246 to provide output to the user as well as a keyboard 248, a touchpad 252, and microphone 256 for the user to provide input to the information handling system 200.

During operation of the information handling system 200, a user may engage in AI-supported capability intent actions using an AI productivity tool software module 262 that leverages AI technologies described herein in order to execute a service, hardware or software operation, response, or other function in response to a user-query input. Again, to facilitate this, the information handling system 200 may include an AI productivity tool software module 262 and an AI productivity tool subagent 266 to select among a plurality of available size-variant ML model algorithms 281, 282, 283 for one or more identified productivity-tool operation types stored in a machine learning module algorithm database 280 to execute the one or more identified productivity-tool operations to process user-query inputs and determine responsive capabilities. These responsive capabilities, when determined, may then be executed via one or more AI productivity tool-enablable software applications 290 or execution of hardware or firmware operations according to an embodiment of the present disclosure. As described herein, the AI productivity tool software module 262 and AI productivity tool subagent 266 may be executed by a hardware processor 202 or other hardware processing device (e.g., EC 204, GPU 206, APU 208, NPU 210) on the information handling system 200 thereby allowing the methods described herein to be carried out on-the-box such that a wired or wireless network connection to a network is not necessary for operation of the method. In another embodiment, some modules, databases, and/or processing resources may be maintained on a remote server such that a wired or wireless network connection can be made with these remote servers and the method may be implemented as described herein.

The AI productivity tool software module 262 may include any artificial intelligence-based productivity tool to assist in interfacing with and execution of one or more AI productivity tool-enablable software applications 290 and receive query inputs from a user and generate responses at an information handling system 200 in an embodiment. The AI productivity tool software module 262 may be loaded on-the-box by a manufacturer in software and may include chatbot features, virtual assistant features, and other artificial intelligence features that allow a user to provide input to the information handling system 200 via, for example, audio input at the microphone 256, touch input at the touchpad 252, and/or alphanumeric input at the keyboard 248. The AI productivity tool software module 262 with generative artificial intelligence, process a user-input query and execute one or more capabilities that include hardware and software operations, functions, software services, or responses using one or more AI productivity tool-enablable software applications 290. Examples of types of AI productivity tool software modules 262 may include Cortana® by Microsoft®, Copilot® by Microsoft®, Siri® by Apple® Inc., Gemini® by Google AIR, ChatGPT® by OpenAI®, and Amazon Alexa® by Amazon®, among others. It is appreciated that the information handling system 200 may include any proprietary AI productivity tool software module 262 installed by an information handling system 200 manufacturer and used to interface with the information handling system 200 and the operations thereon. In various embodiments, the hardware processor 202 or other alternative hardware processing resources (e.g., EC 204, GPU 206, APU 208, NPU 210) of the information handling system 200 may execute computer-readable program code instructions of the AI productivity tool software module 262 with its AI productivity tool plug-in 264 and monitor for user input for a user query at a microphone 256, keyboard 248, touchpad 252, or other input device for the AI productivity tool software module 262 to engage in determining capability intent actions responsive to the user-query input.

The AI productivity tool software module 262, executing on the hardware processor 202 (e.g., a CPU) or other hardware processing resource (e.g., EC 204, GPU 206, APU 208, NPU 210), may interface with other hardware components and with the AI productivity tool-enablable software applications 290 and one or more ML model algorithm variants 281, 282, 283 on the information handling system 200 via an AI productivity tool plug-in 264. The AI productivity tool plug-in 264 may be any software or firmware that allows the AI productivity tool software module 262 to perform those responsive capability actions at the information handling system 200 based on user-query input (e.g., typed, spoken words, images, etc.) provided from the user. The AI productivity tool plug-in 264 may be used by the AI productivity tool software module 262 and AI productivity tool subagent 266 to interface with any number of AI productivity tool-enablable software applications 290 executing or executable on the information handling system 200 according to embodiments herein.

The information handling system 200 also includes the AI productivity tool subagent 266 of the AI productivity tool software module 262. The AI productivity tool subagent 266 may be any software and/or firmware executable by the hardware processor 202 or other ML model algorithm execution provider hardware processor 204, 206, 208, 210 of the information handling system 200 to interface with one or more of the plurality of the AI productivity tool-enablable software applications 290 to provide AI enabled capabilities within those AI productivity tool-enablable software applications (e.g., 290, 291, 292, 293, 294, 295, 296, 297) for responsive hardware or software operations, functions, software services, or responses to user input queries. Examples of AI productivity tool-enablable software applications 290 include a remediation (AMDS) software application 291, Dell® Optimizer® software application 292, Dell® Trusted Device® software application 293, Dell® Display and Peripheral Manager® software application 294, AWCC software application 295, Dell® Support Assist® software application 296, virtual assistant module 297. In an embodiment, the computer-readable program code instructions of the software applications and modules described herein (e.g., 290, 291, 292, 293, 294, 295, 296, 297) may operate wholly “on-box” within the information handling system 200 or be sub-agents on-box for interfacing with remote software systems executing at remote server locations such as the remote policy management server described herein. In an embodiment, the AI productivity tool subagent 266 may be used to direct the execution of various modules in support of the AI productivity tool-enablable software applications 290 and AI productivity tool software module 262 described herein. Additionally, the AI productivity tool subagent 262 may be provided with access to the BIOS and OS of the information handling system 200 to determine user-query intent values, match these with generated capability intents, and to conduct the capability intent actions pursuant to the user's query input provided via the AI productivity tool software module 262 or with an interface of one of the AI productivity tool-enablable software applications 290.

In an embodiment, the hardware processor 202 (such as a CPU) or other hardware processing resource (e.g., EC 204, GPU 206, hardware processor 202, APU 208, or NPU 210) executing computer-readable program code instructions of the AI productivity tool subagent 266 that may include an intent identification software application 268. The intent identification software application 268 may engage with a machine learning model requesting module 276 to have one of a selected size variant ML model algorithm 281, 282, or 283 from among a plurality of available ML model algorithms 281, 282, 283 loaded and executed on the hardware processor in order to conduct an identified productivity-tool operation type. For example, initially, a selected size-variant ML model may be used to determine the query intent value using an embedding ML model algorithm to embed received user query input as a vectorized query intent value. The embedding ML model algorithm may have a plurality of size-variant ML model algorithms 281, 282, or 283 to select from to accomplish this embedding productivity-tool operation type. Another selected size-variant ML model may be used to correlate or match a query intent value with a capability intent action to be conducted responsive to the received user-query inputs for a semantic or lexical matching ML model algorithm to conduct the similarity query intent to capability matching identified productivity-tool operation in other embodiments. Again, the capability matching identified productivity-tool operation may have a plurality of size-variant ML model algorithms 281, 282, or 283 to select from for accomplishing a query intent to capability matching ML model algorithm.

The execution of the computer-readable program code instructions of the intent identification software application 264 may call a software development kit (SDK) module 270. The SDK module 270 may include any computer-readable program code instructions that is executed by the hardware processor 202 or other hardware processing resource to request that a selected size variant ML model algorithm 281, 282, 283 from among a plurality of available size variant ML model algorithms 281, 282, 283 for a particular, identified productivity-tool operation type be invoked to support one or more productivity-tool operations for an identification of, in an embodiment, a capability intent action responsive to a received user-query inputs from a user.

For example, an identified productivity-tool operation type may require a selected size-variant ML model algorithm 281, 282, or 283 and may include a query input-to-intent ML model algorithm that receives the user-query input, and with an embedding algorithm generates a vectorized query intent value for the user-query input and runs a semantic or lexical similarity matching algorithm to correlate it with a capability intent value. In the embodiments herein, each of the identified productivity-tool operation type ML model algorithms may include a plurality of available size-variant ML algorithms such as a small ML model algorithm variant 281, a default ML model algorithm variant 282, and a large ML model algorithm variant 283 each grouped together as size-variant ML model algorithms each of the identified productivity-tool operation type (e.g., variants of the query input-to-intent ML model algorithm). For example, the small ML model algorithm variant 281 may be a “small” variant of the query input-to-intent ML model algorithm. In another example, the default ML model algorithm variant 282 may be a “default” sized variant query input-to-intent ML model algorithm. Furthermore, in this example, the large ML model algorithm variant 283 may be a “large” variant of the query input-to-intent ML model algorithm. Each of these variants of the ML model algorithm (e.g., 281, 282, and 283) for each of the identified productivity-tool operation types may include varying number of parameters and bit sizes with each of the one or more size-variant ML model algorithms having disparate precision to conduct any identified productivity tool operation types to, in an embodiment, ultimately identify and execute the capability intent action responsive to the user-query input received at the AI productivity tool software module 262 from the user. It is appreciated that the ML model algorithms stored within the ML model algorithm database 280 may have one or more size-variants such that any given ML model algorithm for each of the identified productivity-tool operation types could include a “small,” “default,” or “large” variant for execution by the hardware processor 202 or other processing device in order for one or more of AI productivity tool-enablable software applications 290 to perform responsive software services, operations, or responses based on the user-query input.

In another example embodiment, another identified productivity-tool operation type of ML model algorithm may also include a query intent-to-capability matching ML model algorithm that includes plural available size-variant ML model algorithms 281, 282, 283. For example, a small ML model algorithm variant 281 of the query intent-to-capability matching ML model algorithm, a default ML model algorithm variant 282 of the query intent-to-capability matching ML model algorithm, and a large ML model algorithm variant 283 of the query intent-to-capability matching ML model algorithm may be size variants for this identified productivity-tool operation type. Whichever ML model algorithm size variant 281, 282, 283 receives the vectorized query intent value as input, that size-variant ML model algorithm is executed to match a selected vectorized query intent value to a vectorized capability intent value associated with the AI productivity tool-enablable software application 290 via a semantic, lexical or blended similarity correlation algorithm to identify a capability that can serve as the capability intent action responsive to a user-query input.

It is appreciated that the selected ML model algorithm variant 281, 282, or 283 for particular identified productivity-tool operation type may satisfy an interface contract 274 requested by the intent identification software application 268 such that the query intent value from the user-query inputs may be similarity matched to an available capability associated with one of the plurality of AI productivity tool-enablable software applications 290 as the responsive capability intent action can be matched to the user's query input. The interface contract 274 described herein defines the requirements that selected ML model algorithm variant 281, 282, or 283 from among a plurality of available size-variant ML model algorithms are to have in order to be able receive a specific type of input from the AI productivity tool software module 262, the intent identification software application 268 or any AI productivity tool-enablable software application 290 and to provide a specific type of output to the AI productivity tool software module 262, the intent identification software application 268 and/or AI productivity tool-enablable software applications 290. In an embodiment, the interface contract 274 is generated by an AI productivity proxy API 272 invoked by the SDK module 270 in order to identify the specific ML model algorithm variant 281, 282, or 283 selected from a plurality for the particular identified productivity-tool operation type that provides the appropriate output to the intent identification software application 268. The execution of the computer-readable program code of the intent identification software application 268 allows a user to interface with the AI productivity tool software module 262 (e.g., via text, audio, images, etc.) and have a responsive action, such as a hardware operation or adjustment, software service, or other response from the information handling system 200 executed that satisfies the user's query input.

It is appreciated, however, that execution of certain size-variant ML model algorithm such as a large ML model algorithm variant 283 may lead to significant system resource consumption such as hardware processing resources thereby creating performance impacts where a specific hardware processor (e.g., 202, 204, 206, 208) is used. In an embodiment, the AI productivity tool subagent 266 includes computer-readable program code instructions 218 of a system state component discovery software application 284 to discover any and all hardware capabilities as well as any available ML model algorithm execution provider hardware processing resources such as the hardware processor 202, the EC 204, the GPU 206, the APU 208, and the NPU 210 shown in FIG. 2.

As described in embodiments herein, a hardware processing resource may execute computer-readable program code instructions of the system state component discovery software application 284 causes runtime telemetry data to be gathered for hardware components as well as for execution in the information handling system 200. This runtime telemetry data may include data describing a current operating environment within the information handling system 200 while an ML model algorithm execution provider hardware processing resource 202, 204, 206, 208, 210 executes or will execute the invoked one or more size-variant ML model algorithms 281, 282, or 283. It is appreciated, however, that not all of the ML model algorithm execution provider hardware processing resources are available on the information handling system and the execution of the computer-readable program code instructions 218 of the system state component discovery software application 284 identifies whether a hardware processor 202, EC 204, GPU 206, APU 208, NPU 210 is available to execute the size-variant ML model algorithms selected depending on state of components such as the various small ML model algorithm variants 281, default ML model algorithm variants 282, and large ML model algorithm variants 283 of each of the ML model algorithms described herein. In an embodiment, in order to obtain the data related to the available ML model algorithm execution provider hardware processors 202, 204, 206, 208, 210 and the runtime telemetry data, the system state component discovery software application 284 may be operatively coupled to any number of hardware drivers 288. The computer-readable program code instructions of the hardware drivers 288 may identity the existence and state of one or more of the ML model algorithm execution provider hardware processors 202, 204, 206, 208, 210 as well as any other hardware devices such as memory devices, power sources, etc. The determination of the existence and state of the hardware devices allows for the AI productivity tool subagent 266 to select among the small ML model algorithm variant 281, the default ML model algorithm variant 282, and large ML model algorithm variant 283 in an embodiment.

Further, execution of the computer-readable program code instructions 218 of the system state component discovery software application 284 causes runtime telemetry data to be gathered. This runtime telemetry data may include data describing a current operating environment within the information handling system 200 while an ML model algorithm execution provider hardware processor 202, 204, 206, 208, 210 executes the invoked one or more size-variant ML model algorithms 281, 282, 283. In order to obtain the data related to the impact on the available ML model algorithm execution provider hardware processors 202, 204, 206, 208, 210 and the runtime telemetry data during execution of the size-variant ML model algorithms, the system state component discovery software application 284 may be operatively coupled to any number of hardware drivers 288.

Similarly, the state of the information handling system 200 components gathers telemetry of current execution levels of hardware processors or states of other components in anticipation of a particular, identified productivity-tool operation type. Thus, the computer-readable program code instructions 218 of the hardware drivers 288 may identity the existence of one or more of the ML model algorithm execution provider hardware processors 202, 204, 206, 208, 210 as well as any telemetry data associated with the operation of the ML model algorithm execution provider hardware processors 202, 204, 206, 208, 210 such as current consumption of hardware processors (e.g., peta operations per second (pTops) exa operations per second (eTops), current workloads and usage metrics). It is appreciated that any other runtime telemetry data may be retrieved using any hardware drivers 288 and may include, for example, a hardware driver associated with the PMU that provides battery relative state-of-charge (RSOC) data (e.g. a range of 0% to 100%). It is appreciated that any other telemetry data may be acquired by the system state component discovery software application 284 via the hardware drivers 288 that would provide additional information related to resource consumptions at the information handling system 200 as the ML model algorithm variants 281, 282, 283 are being executed by or in anticipation of execution by an ML model algorithm execution provider hardware processor 202, 204, 206, 208, 210. In a specific example embodiment, a hardware processing device may execute computer-readable program code instructions 218 of a Dell® Telemetry Manager®. The execution of the computer-readable program code instructions 218 of the Dell® Telemetry Manager® may automatically cause this telemetry data to be retrieved and sent to the system state component discovery software application 284 for processing and use in determining whether an ML model algorithm execution provider hardware processor 202, 204, 206, 208, 210 and selecting one ML model algorithm variant from among a plurality of available size-variant ML model algorithms 281, 282, 283 in anticipation of executing a particular, identified productivity-tool operation type by the AI productivity tool software module 262, the AI productivity tool software module 262, or the AI productivity tool-enablable software applications 290 is appropriate for the current operating conditions.

In an embodiment, a hardware processing device hardware processor (e.g., 202, 204, 206, 208, 210) may execute computer-readable program code instructions 218 of a workload orchestrator 286 to initially receive the data describing the gathered runtime telemetry from the system state component discovery software application 284. After receiving this telemetry data, the execution of the computer-readable program code instructions 218 of the workload orchestrator 286 may cause the AI productivity tool subagent 266 to monitor the execution of the identified ML model algorithm variant by the ML model algorithm execution provider hardware processor 202, 204, 206, 208, 210 and determine if the execution of the selected size-variant ML model algorithms 281, 282, 283 by the identified ML model algorithm execution provider hardware processor 202, 204, 206, 208, 210 meets a quality of service (QoS) metric threshold used to optimize the operating environment within the information handling system.

It is appreciated that, for example, the execution of a large ML model algorithm variant 283 of any ML model algorithm via any given ML model algorithm execution provider hardware processor 202, 204, 206, 208, 210, a higher consumption of power and processing resources may be realized relative to the small ML model algorithm variant 281 of that ML model algorithm for a particular, identified productivity-tool operation type. However, the precision of the output provided via execution of the small ML model algorithm variant 281 of the ML model algorithm may be significantly lower than the precision of the output provided via execution of the large ML model algorithm variant 283. In an embodiment, therefore, the workload orchestrator 286 and system state component discovery software application 284 may operate together in order to optimize quantization techniques that includes a focus on selecting the appropriate size-variant ML model algorithm that consumes the least amount of processing resources, the least amount of power, the least amount of memory bandwidth, the lowest latency, and the highest throughput, without losing too much accuracy and precision in the output of the selected or to-be selected size-variant ML model algorithms of an identified common productivity-tool operation type while also maintaining a QoS metrics that do not exceed the QoS metric threshold. In an embodiment, the QoS metrics threshold may be set to a specific level of consumption of processing capability of ML model algorithm execution provider hardware processors (e.g., >eTops/second), consumption of RAM memory, or of power consumption (e.g., >40 W/hour) that may affect operations of the information handling system 200 and impact a user experience with the same.

In an embodiment, the small ML model algorithm variant 281, default ML model algorithm variant 282, and large ML model algorithm variant 283 associated with any given ML model algorithm may each include a disparate number of parameters and bit sizes that identify them as a “small,” “default,” and “large” ML model algorithm variant. For example, a look-up table may be provided the specifically defines each of the small ML model algorithm variant 281, the default ML model algorithm variant 282, and the large ML model algorithm variant 283 based on this criterion. An example look-up table is presented in Table 1 presented herein.

As described herein, the ML model algorithm variants may include disparate number of parameters and disparate quantization sizes. For example, a “large” ML model algorithm variant may include Llama30b which is a large language model (LLM) that has 30 billion parameters and can be executed on any of a CPU 202, a GPU 206, or an NPU 210 as shown in Table 1 above and may require a large size of RAM (e.g., 4-6 GB) and may have a large size file with a high processing requirement for recursions and other functions. The availability of these hardware processors or of enough RAM, however, is determined while this “large” ML model algorithm is being executed. Where hardware processing resources are not available at one of the CPU 202, a GPU 206, or an NPU 210, the hardware processor may be switched prior to the selection of this “large” ML model algorithm and/or as the “large” ML model algorithm is being executed to another hardware processor. In some embodiments, the selection of the “large” ML model algorithm for execution may be determined to cause QoS thresholds to be exceeded for one or more systems of the information handling system 200, such as hardware processor capability, RAM usage, power consumption or others. In such a case, if a confidence score threshold for a smaller size variant ML model output is sufficiently met, the smaller size variant ML model algorithm may be selected instead.

Similarly, a “default” ML model algorithm variant may include Llama30b-cpu-int8 which has 30 billion parameters and has a quantization size of 8 bits. This “default” ML model algorithm may be optimized to be executed on the CPU 202, but other “default” ML model variants such as Llama30b-gpu-fp16 and Llama30b-npu-int8 may be optimized for execution on the GPU 206 and NPU 210, respectively. These default or medium size variant ML model algorithms may require less RAM usage and lower levels of processing with fewer recursive cycles or other processes. Thus, where the CPU 202 does not have enough processing capacity to execute its Llama30b-cpu-int8 “default” ML model, the GPU 206 and NPU 210 may be selected to execute their respective “default” or medium sized ML model algorithm variant as described herein. Similarly, if a confidence score threshold for output is sufficient, a “small” size variant ML model algorithm may be selected instead for a particular, identified productivity-tool operation in yet other embodiments. This may use even less processing requirements or RAM for execution in some embodiments. It is appreciated that, based on the processing resources available, the type of CPU 202, a GPU 206, or an NPU 210 on the information handling system 200, as well as other factors such as available RAM may change what is determined to be a “large,” a “default,” and a “small” ML model algorithm as well as the sizes of the ML model algorithms that can be executed on the information handling system 200.

In an embodiment, when the workload orchestrator 286 determines that the execution of a selected, size-variant ML model algorithm from a plurality of available size-variant ML model algorithms 281, 282, 283 by a selected ML model algorithm execution provider hardware processor 202, 204, 206, 208, 210 does not meet or falls below the QoS metric threshold (e.g., a specific level of remaining processing capability or processing usage, remaining RAM occupancy or RAM usage, power consumption, a battery RSOC, or current hardware processing consumption per hardware processor and RAM availability based on currently executing software applications, etc.), the workload orchestrator 286 may switch to another or second ML model algorithm execution provider hardware processor 202, 204, 206, 208, 210 to execute the selected size-variant ML model algorithm for the identified productivity-tool operation type. This change may be due to the system state component discovery software application 284 and workload orchestrator 286 being used to determine that hardware processing resource consumption exceeded or does not meet a QoS metric at the previous ML model algorithm execution provider hardware processor 202, 204, 206, 208, 210 and, therefore, a different ML model algorithm execution provider hardware processor 202, 204, 206, 208, 210 should be used instead based on detected telemetry data of the information handling system. This may occur where, for example, the hardware processor 202 (e.g., CPU) was the originally selected ML model algorithm execution provider hardware processor but other processes are or will be executed on the hardware processor 202 and the execution of the selected size-variant ML model algorithm 281, 282, or 283 will result in the QoS metric being met, such as processing availability, RAM occupancy levels, or power consumption, to cause a degradation in operation of the information handling system 200. In such an embodiment, the workload orchestrator 286 may provide instructions to the intent identification software application 268 to switch from the first ML model algorithm execution provider hardware processor 202 to a second ML model algorithm execution provider hardware processor 204, 206, 208, or 210.

In another embodiment, the workload orchestrator 286 may determine that the execution of the selected size-variant ML model algorithm from among a plurality of available ML model algorithms 281, 282, 283 for execution of an identified productivity-tool operation type by the selected ML model algorithm execution provider hardware processor 202, 204, 206, 208, 210 will result in the QoS metric being met, such as processing availability, RAM occupancy levels, or power consumption, to cause a degradation in operation of the information handling system 200, the workload orchestrator 286 switches the size-variant ML model algorithm from among a plurality of available ML model algorithms to another or second size-variant ML model algorithm 281, 282, 283 to be executed on the ML model algorithm execution provider hardware processor 202, 204, 206, 208, 210. The switching from a first ML model algorithm 281, 282, or 283 to another or second ML model algorithm 281, 282, or 283 may be done when the workload orchestrator 286 determines that a QoS metrics threshold (e.g., based on current hardware processing consumption per hardware processor, RAM availability, currently executing software applications, a specific level of power consumption, a battery RSOC, etc. or a combination thereof) has been exceeded and that a lower resolution or accuracy output from another smaller size variants ML model algorithm 281, 282 (e.g., from a default ML model algorithm variant 282 or a small ML model algorithm variant 281) would be sufficient to complete the execution of an identified productivity-tool operation type described herein. In an embodiment, the workload orchestrator 286 may provide instructions to the intent identification software application 268 to switch from executing the first size variant ML model algorithm 281, 282, 283 to executing the second size variant ML model algorithm 281, 282, 283 when a second size variant ML model algorithm 281, 282, or 283 still meets a confidence score threshold for precision of the output to achieve the identified productivity-tool operation.

In an embodiment, the workload orchestrator 286 may also engage in a confidence scoring process that calculates a confidence score related to the selection of the execution of any given ML model algorithm 281, 282, 283 by any given ML model algorithm execution provider hardware processor 202, 204, 206, 208, 210 relating to precision in executing the identified productivity-tool operation type common to the plurality of available size-variant ML model algorithms 281, 282, 283. Again, in an embodiment, the confidence score may be provided during the execution of the ML model algorithm 281, 282, 283 with the probabilities of accuracy for outputs for each class of output (e.g., probabilistic similarity correlation, accuracy in neural network output, or the like) in the execution of the ML model algorithm 281, 282, 283 that the ML model algorithm 281, 282, 283 serving as the confidence score. Thus, in those embodiments where the ML model algorithms 281, 282, 283 are probabilistic, the output probability is used as the confidence score described herein. For example, in an embodiment where neural networks are used, the neural network is trained to provide probability that each class of data output it is predicting (e.g., for correlation) has an accuracy probability which is the confidence score. In another example embodiment, a similarity matching search (e.g., a semantic search) ML model algorithm or other correlation ML model algorithm, the confidence score may be the score with 1-cosine_distance (user_input, known_intent) where the cosine_distance is between 0 and 1 such that the more confident values are close to 0. Thus, a maximum score relative to a known_intent value at 100% confidence is the overall score used to decide the confidence score in some embodiments. Thus, if the output from the execution of a specific ML model algorithm 281, 282, 283 for an identified productivity-tool operation type (e.g., an identified intent provided via output from the small variant of the query input-to-intent ML model algorithm) does not have a high confidence score and an inaccurate determined query intent value, similarity matching output or other output of the specific size variant ML model algorithm is impactful to operations of the information handling system 200 or user, the user-query input is again ran through a relatively larger ML model algorithm 281, 282, 283 (e.g., from a “small” to a default ML model algorithm variant 282 or a large ML model algorithm variant 283 variant of the query intent determination or query intent-to-capability matching ML model algorithm) in order to increase the confidence score for a more precise result in executing productivity tool operations for responding to a query input. This may be done while also working within the constraints of the QoS metric thresholds such that an optimum level of resources are consumed to minimize or not impact other hardware processing on the information handling system 200 while the confidence of the output from the ML model algorithm 281, 282, 283 is sufficient. In an embodiment, the switch between ML model algorithm execution provider hardware processors 202, 204, 206, 208, 210 and selected size-variants of ML model algorithms 281, 282, 283 may be completed within a feedback loop process in order to achieve these goals described herein.

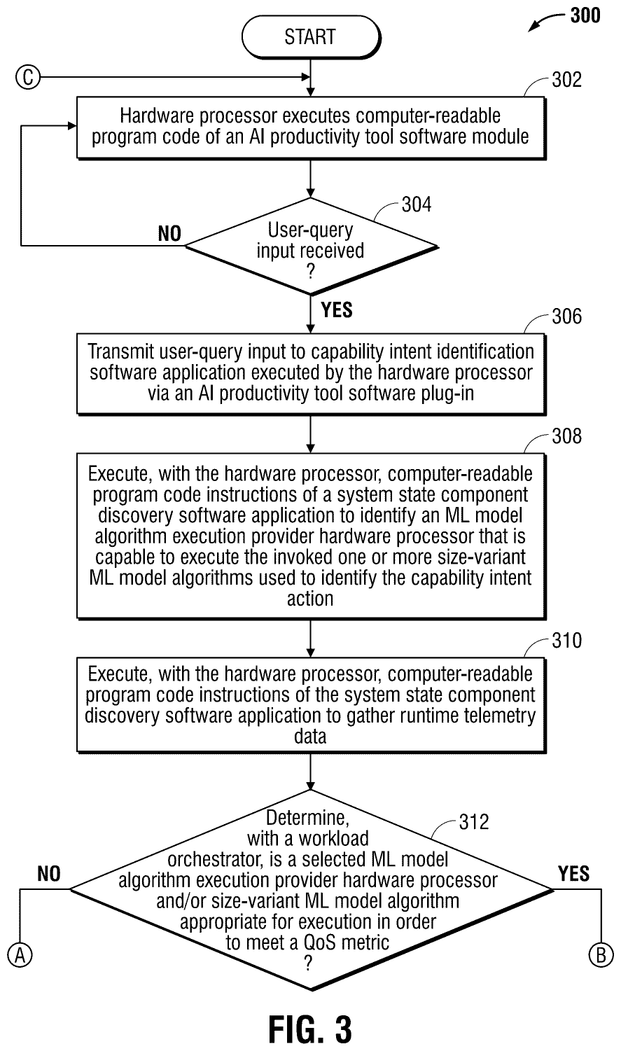

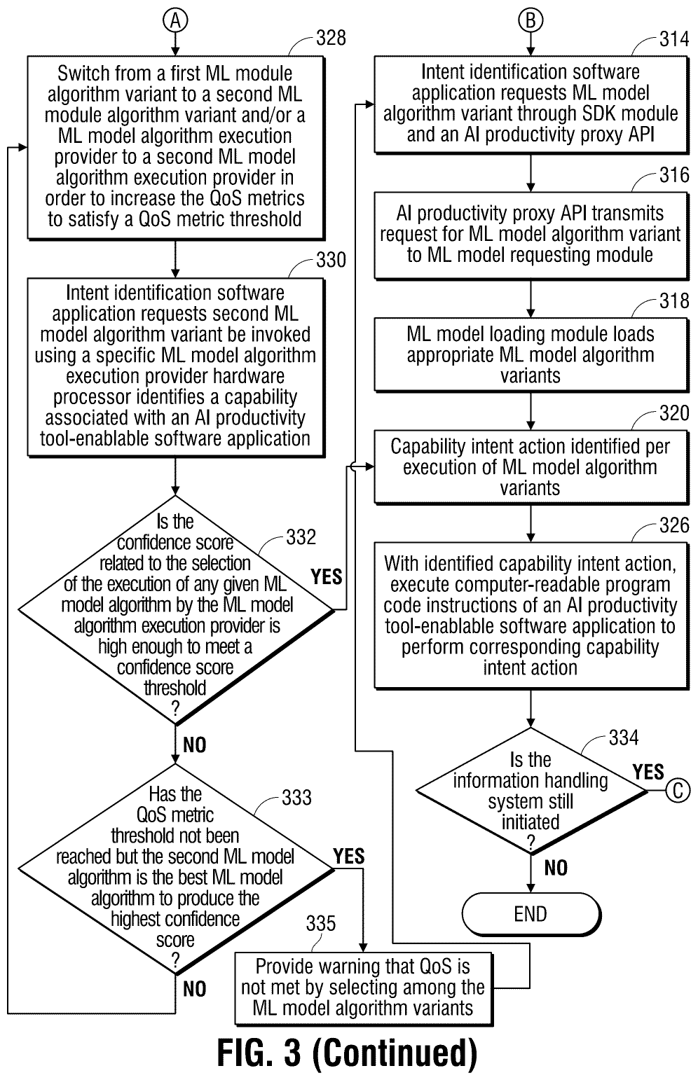

FIG. 3 is a flow diagram showing a method 300 of implementing contextual QoS machine learning model algorithm selection from among a plurality of available ML model algorithm size variants for a particular identified productivity-tool operation in an information handling system according to an embodiment of the present disclosure. The method 300 described in connection with FIG. 3 may be operated on an information handling system such as an information handling system (e.g., 100, 200) described in connection with FIG. 1 or 2. In an embodiment, the systems and methods described herein may operate on the information handling system such that the method is executed “on-the-box” such that a wired or wireless network connection to a network is not necessary for operation of the method. In another embodiment, some modules, databases, and/or processing resources may be maintained on a remote server and a wired or wireless network connection can be made with these remote servers and the method may be implemented as described herein.

The method 300 may include, at block 302, the hardware processor or other hardware processing device of the information handling system executing computer-readable program code instructions of an AI productivity tool software module including access to one or more AI productivity tool-enablable software applications executing on the information handling system. In an embodiment, AI productivity tool software module may be any application that can receive input from a user such as text input via the keyboard, image or touch input via a touchpad, or speech input via the microphone, for example. In some embodiments, text or audio may be received by an interface of the one or more AI productivity tool-enablable software modules and the interface managed by the AI productivity tool sub-agent. In an embodiment, the AI productivity tool software module may include a virtual assistant-type AI software agent. In various embodiments, the hardware processor or other alternative hardware processing resources of the information handling system may execute computer-readable program code instructions of the AI productivity tool software module with its AI productivity tool software plug-in and monitor for user-query inputs at a microphone, keyboard, or other input device for the AI productivity tool subagent to engage in capability intent actions responsive to the user-query inputs.

Therefore, at block 304, the method 300 also includes determining whether any user-query input has been received at the AI productivity tool software module. Where, at block 304, no user-query input is received, the method 300 returns to block 302 with the AI productivity tool software module continuing to monitor for this input. Where, at block 304, the AI productivity tool software module does detect and receive user-query input, the method 300 continues to block 306 with the user-query input being transmitted to an intent identification software application being executed by the hardware processor of the information handling system via an AI productivity tool software plug-in. In an embodiment, the intent identification software application may be part of an AI productivity tool subagent that provides AI productivity services as described herein.

In an embodiment, at block 306, the intent identification software application may invoke one or more ML model algorithms in order to execute one or more productivity-tool operations to identify the query intent value and match to an appropriate capability intent value of an AI productivity tool-enablable software application that can perform the responsive capability intent action. This will cause the intent identification software application to signal the execution of one or more AI productivity tool-enablable software applications which may then execute one or more ML model algorithms as described herein to provide responsive output of a capability intent action to the user-query input for the user and/or change features, settings, or other actions on the information handling system for the user.

Proceeding to block 308, the method 300 may include the hardware processor or any other hardware processing device executing computer-readable program code instructions of a system state component discovery software application to identify an ML model algorithm execution provider hardware processing resource that is capable to execute the invoked one or more size-variant ML model algorithms used to execute one or more identified productivity-tool operations to identify the capability intent action responsive to a user-query input. As described herein, each of the ML model algorithm for identified productivity-tool operation types stored on a machine learning model algorithm database may include a plurality of available size-variant ML model algorithms grouped for each productivity-tool operation types. In an example embodiment, these size-variant ML model algorithms may include a small ML model algorithm variant, a default ML model algorithm variant, and a large ML model algorithm variant grouped for each productivity-tool operation type. For example, a query input-to-intent ML model algorithm may include a small ML model algorithm variant of the query input-to-intent ML model algorithm, a default ML model algorithm variant of the query input-to-intent ML model algorithm, and a large ML model algorithm variant of the query input-to-intent ML model algorithm grouped for a productivity-tool operation type to receive a user-query input and embed the same in a query intent value. Additionally, a query intent-to-capability matching ML model algorithm may include its own set of small ML model algorithm variant, default ML model algorithm variant, and large ML model algorithm variant grouped to conduct a semantic, lexical, or blended similarity search between a user query intent and capability intents as used in the methods described herein.

Also, the discovery of each of the ML model algorithm execution provider hardware processor (e.g., a CPU, an EC, a GPU, an APU, and/or the like) available on the information handling system may occur via execution of computer readable code instructions of the system state component discovery software application in embodiments herein. It is appreciated that not all of a CPU, EC, APU, GPU, NPU as potential ML model algorithm execution provider hardware processors are detected and available on the information handling system and the execution of the computer-readable program code instructions of the system state component discovery software application identifies whether a hardware processor, EC, GPU, APU, NPU is available. The identification of whether a given hardware processor, EC, GPU, APU, NPU, or other hardware processing resource is available is further correlated with whether the ML model algorithm execution provider hardware processor is identified by a workload orchestrator as configured to execute any of the size-variant ML model algorithms such as the various small ML model algorithm variants, default ML model algorithm variants, and large ML model algorithm variants grouped for each of the ML model algorithms for identified productivity-tool operation types described herein.

Further, execution of the computer-readable program code instructions of the system state component discovery software application causes runtime telemetry data to be gathered at block 310. This runtime telemetry data may include data describing a current operating environment within the information handling system while an ML model algorithm execution provider hardware processor executes to execute an invoked one of a plurality of available size-variant ML model algorithms. Also, in some embodiments runtime telemetry data may be gathered in anticipation or before execution of a selected one of a plurality of available size-variant ML model algorithms to conduct an identified productivity-tool operation type to determine information handling system component states. In order to obtain the data related to the available ML model algorithm execution provider hardware processors and the runtime telemetry data during execution of size-variant ML model algorithms, the system state component discovery software application may be operatively coupled to any number of hardware drivers, in an embodiment. The computer-readable program code instructions of the hardware drivers may identify the existence of one or more of the ML model algorithm executions as well as any telemetry data associated with the operation of the ML model algorithm execution provider hardware processors such as current consumption of processors (e.g., peta operations per second (pTops) exa operations per second (eTops), current workloads and usage metrics) to be gathered by the system state component discovery software application 284. It is appreciated that any other runtime telemetry data may be retrieved using any hardware drivers and may include, for example, a hardware driver associated with the PMU that provides battery relative state-of-charge (RSOC) data (e.g. a range of 0% to 100%), memory occupancy of RAM as a portion or percentage of available RAM or the like.

It is further appreciated that any other telemetry data may be acquired by the system state component discovery software application via the hardware drivers that would provide additional information related to resource consumption of hardware components at the information handling system as the ML model algorithm variants are being executed or about to be executed by a ML model algorithm execution provider hardware processor. In a specific example embodiment, a hardware processing device may execute computer-readable program code instructions of a Dell® Telemetry Manager® to gather the runtime telemetry data during or in anticipation of execution of a selected size-variant ML model algorithm. The execution of the computer-readable program code instructions of the Dell® Telemetry Manager® may automatically cause this telemetry data to be retrieved and sent to the system state component discovery software application for processing and use in determining whether an available ML model algorithm execution provider hardware processor and currently executed or to-be-executed size-variant ML model algorithms selected from a plurality of available size-variant ML model algorithms are appropriate for the current operating conditions.

At block 312, the hardware processor may also execute computer-readable program code instructions of a workload orchestrator. In an embodiment, the system state component discovery software application may transmit the runtime telemetry data to the workload orchestrator for the workload orchestrator to then determine if the ML model algorithm variant selected to be invoked by an intent identification software application for any identified productivity-tool operation type would be appropriate to be executed by a selected ML model algorithm execution provider hardware processor and under the detected current state of hardware components on the information handling system. As described herein, a small ML model algorithm variant, a default ML model algorithm variant, and a large ML model algorithm variant associated with any given ML model algorithm identified productivity-tool operation type to be executed by the intent identification software application or the AI productivity tool software module may each include a disparate number of parameters and bit sizes that identify them as a “small,” “default,” and “large” ML model algorithm variant. For example, a look-up table may be provided that specifically defines each of the small ML model algorithm variant, the default ML model algorithm variant, and the large ML model algorithm variant based on certain criterion.

Each of these size variants of the ML model algorithm may include disparate number of parameters and bit sizes with each of the plurality of available size-variant ML model algorithms of a similar type which may yield different levels of precision to, in an embodiment, execute any of the identified productivity-tool operations to ultimately identify the capability intent action responsive to the user-query input received at the AI productivity tool software module from the user. These differing size-variant ML model algorithms of a similar function for each identified productivity-tool operations will have trade-offs between precision and ML model algorithm execution provider hardware processing resources consumed or latency of operation among other factors in embodiments herein. An example look-up table is presented in Table 1 presented herein which further includes a suggested corresponding ML model algorithm execution provider hardware processor to be used to execute a selected ML model algorithm variant. Additionally, because the workload orchestrator has received the current telemetry data described herein, an appropriate ML model algorithm variant and ML model algorithm execution provider hardware processor may be identified based on current operating conditions of the information handling system hardware processor and for the state of the hardware components on the information handling system such that a QoS metric threshold for processor consumption, memory consumption, power consumption or other factors are not met such that the operation of the information handling system is degraded.

Where, at block 312, the workload orchestrator has determined that a ML model algorithm variant selected by the intent identification software application or the AI productivity tool software module is appropriate and a specific ML model algorithm execution provider hardware processor is appropriate to execute that ML model algorithm variant, the method 300 may continue with the workload orchestrator allowing the intent identification software application to request the ML model algorithm variant via an SDK module and an AI productivity proxy API at block 314.

As described herein, at block 314, the SDK module may include any computer-readable program code instructions that is executed by the hardware processor or other hardware processing resource to request that a ML model algorithm variant be invoked to support an identification of, in an embodiment, a capability intent action based on received user-query inputs from a user using one or more ML algorithms to execute identified productivity-tool operation type. For example, the ML model algorithm variant may include a small, default, or large variant for each identified productivity-tool operation type such as a query input-to-intent ML model algorithm that receives the user-query input, and for an embedding algorithm that generates a vectorized query intent value for the user-query input as another identified productivity-tool operation type. Yet another identified productivity-tool operation type may be a query intent-to-capability similarity matching, the small ML model algorithm variant may be a “small” variant of the query intent-to-capability similarity matching ML model algorithm, the default ML model algorithm variant may be a “default” (e.g., medium) sized variant query intent-to-capability similarity matching ML model algorithm, and, the large ML model algorithm variant may be a “large” variant of the query intent-to-capability similarity matching ML model algorithm. Different examples of size variant ML model algorithms are presented in, for example, Table 1 as an example embodiment of available size variant ML model algorithms that may be grouped for execution of any particular identified productivity-tool operation type.

In another example embodiment, the ML model algorithms may also include a small, default, and large variant of a query intent-to-capability matching ML model algorithm of an identified productivity-tool operation to lexically or semantically match a query to a capability for a responsive capability action. Whichever ML model algorithm variant of the query intent-to-capability matching ML model algorithm receives the vectorized query intent value as input, the executed size-variant ML model algorithm then lexically or semantically matches the vectorized query intent value to a vectorized capability intent value associated with the AI productivity tool-enablable software application capabilities via a similarity correlation algorithm to identify a capability that can serve as the capability intent action responsive to a user-query input.

Each of these variants of the ML model algorithm for each identified productivity-tool operation type, such as for the query input-to-intent identified productivity-tool operation type to determine a query intent vectorized value from a received user query input (e.g., audio or text), may include disparate number of parameters and bit sizes with each of the one or more size-variant ML model algorithms available. Each of the variants of the ML model algorithms provide disparate precision to, in an example embodiment, conduct one or more identified productivity-tool operation types to ultimately identify the capability intent action based on the user-query input received at the AI productivity tool software module from the user to generate a responsive action to a user-query input. It is appreciated that the ML model algorithms stored within the ML model algorithm database may have one or more size-variants such that any given ML model algorithm for an identified productivity-tool operation could include grouped “small,” “default,” and “large” variants for execution by the hardware processor or other processing device in order for one or more of AI productivity tool-enablable software applications to perform software services, operations, or responses based on the user-query input.

At block 316, the method 300 also includes the AI productivity proxy API transmitting the request for the selected ML model algorithm variant to the ML model request module for each of the productivity-tool operations to be conducted by the AI productivity tool software module or any AI productivity tool-enablable software applications. Additionally, at block 318, the ML model loading algorithm loads the appropriate ML model algorithm variants of the query input-to-intent ML model algorithm, query intent-to-capability matching ML model algorithm, or any ML model algorithms in support of execution of AI productivity tool-enablable software applications as described herein. These steps at blocks 316 and 318 may be conducted recursively for each of successive AI productivity-tool operations conducted by the AI productivity tool software module and the AI productivity tool-enablable software applications to receive a user query input, determine a response such as a responsive capability, and then execute a responsive capability intent action to the user query input.

The output from the execution of these ML model algorithm variants results in, at block 320, a capability intent action being identified per the execution of the ML model algorithm variants as described in embodiments herein. In an example, the ML model algorithms may include grouped size-variant ML models of query input-to-intent ML model algorithm that receives the user-query input, and with an embedding algorithm generates a vectorized query intent value for the user-query input for later correlation with a capability intent value. The ML model algorithms may also include a query intent-to-capability matching ML model algorithm that receives the vectorized query intent value as input, matches the vectorized query intent value to a vectorized capability intent value associated with the AI productivity tool-enablable software application via a similarity correlation algorithm, and identifies a capability that can serve as the capability intent action responsive to a user-query input.

Returning to block 312, in some instances the selection of the execution of the computer-readable program code of the ML model algorithm variants and/or the selection of the ML model algorithm execution provider hardware processor may not be determined by the workload orchestrator to be appropriate for the current state of components of the information handling system in that a QoS metric threshold or a confidence score of an AI productivity-tool results are not sufficiently met or are such that degradation of performance of the information handling system or the AI productivity tool software module may be experienced. This decision may occur, in an embodiment, prior to the intent identification software application being executed. In another embodiment at block 312, the workload orchestrator may operate under a feedback loop process that monitors future execution of selected ML model algorithm variants by selected ML model algorithm execution provider hardware processors and current execution of the selected ML model algorithm variant by a selected ML model algorithm execution provider hardware processor. This is done so as to determine if a QoS metric threshold has been reached or exceeded or will be exceeded or not met if the intent identification software application or AI productivity-tool software module continues or commences operating with a next selected size-variant ML model algorithm or a particular ML model algorithm execution provider hardware processor. Thus, the operation of the workload orchestrator and the system state component discovery software application may be continuous in order to provide continuous feedback in order to accommodate for any monitored changes in resource consumption at the information handling system at any given time relative to selection of the size variant ML model algorithm from a selection of available ML model algorithms for an identified productivity-tool operation or relative to selection of the ML model algorithm execution provider hardware processor to be used.

Thus, at block 328, the workload orchestrator may switch from a first ML model algorithm variant to a second ML model algorithm variant and/or switch a ML model algorithm execution provider hardware processor to a second ML model algorithm execution provider hardware processor in order to improve the QoS metrics relative to one or more QoS threshold metric such that the QoS metrics no longer exceed or fall below the QoS metric threshold such that performance of the information handling system is unacceptably degraded. It is appreciated that, for example, the execution of a large ML model algorithm variant of any ML model algorithm for one or more identified productivity-tool operation types via any given ML model algorithm execution provider hardware processor may result in a higher consumption of power and processing resources than may be realized relative to the small ML model algorithm variant of that ML model algorithm for that identified productivity-tool operation type. However, the precision of the output provided via execution of the small ML model algorithm variant of the ML model algorithm for that productivity-tool operation type may be significantly lower than the precision of the output provided via execution of the large ML model algorithm variant. In an embodiment, therefore, the workload orchestrator and system state component discovery software application may operate together in order select a size variant ML model algorithm to optimize quantization techniques for levels of input parameters accepted, processing levels, or numbers of recursions conducted for selected size variant ML model algorithm from a plurality of available ML model algorithms for an AI productivity-tool operation type. This selection to switch to another size variant ML model algorithm for an identified productivity-tool operation type is determined such that there is a focus on selecting the appropriate size-variant ML model algorithm that consumes the least amount of processing resources, the least amount of power, the least amount of memory bandwidth, the lowest latency, or the highest throughput, without losing too much accuracy and precision in the output of the selected or to-be selected size-variant ML model algorithms of an identified common productivity-tool operation type. Selection of the selected size variant ML model algorithm to switch to from among the plurality of available size variant ML model algorithms for an identified productivity-tool operation is selected to maintaining QoS metrics that do not exceed the QoS metric threshold but also may be required to satisfy an ML model algorithm confidence score threshold for the size variant ML model algorithm output. In example embodiments, the QoS metrics threshold may be set to a specific level of hardware processing consumption of ML model algorithm execution provider hardware processing resources (e.g., >eTops/second), a level of RAM occupancy during operation (e.g., percentage of total available RAM), or a level of power consumption (e.g., >40 W/hour).

At block 330, similar to blocks 314 through 320, the method 300 includes the intent identification software application and AI productivity tool software module requesting for the second ML model algorithm variant to be invoked and executed on a specific ML model algorithm execution provider hardware processor based on satisfying the QoS metric threshold and ML model algorithm confidence score. The second ML model algorithm variant may be executed by the AI productivity tool software module and intent identification software application such that a capability associated with an AI productivity tool-enablable software application semantically or lexically matching a user query input is identified. Again, the specific selection of the ML model algorithm variant and ML model algorithm execution provider hardware processor may be provided via operation of the workload orchestrator accessing, for example, a look-up table that cross-references each of the available ML model algorithm variants with a suggested ML model algorithm execution provider hardware processor to execute those ML model algorithm variants to satisfy the QoS threshold and confidence score under a detected information handling system telemetry data state. Additionally, in an embodiment, any runtime telemetry data received by the workload orchestrator influences these selections as described herein.

At block 332, the method 300 includes the workload orchestrator also determining if a ML model algorithm confidence score related to the selection of the execution of any given size variant of ML model algorithm by the ML model algorithm execution provider hardware processor is high enough to meet an ML model algorithm confidence score threshold. In an embodiment, the confidence score may be provided during the execution of the ML model algorithm with the probabilities of each class in the execution of the ML model algorithm that the ML model algorithm is predicting serving as the confidence score. Accordingly, in those embodiments where the ML model algorithms are probabilistic, the output probability is used as the confidence score described herein.

Thus, if the output from the execution of a specific size variant ML model algorithm for a particular productivity-tool operation type (e.g., an identified query intent provided via output from the small variant of the query input-to-intent embedding ML model algorithm or a semantic or lexical similarity matching to a capability intent) does not have a high confidence score and an associated query intent value or similarity matching imprecision are impactful to operations of AI productivity tool software module on the information handling system or user, the user-query input is again run through a relatively larger ML model algorithm (e.g., a default ML model algorithm variant or a large ML model algorithm variant of the query input-to-intent embedding ML model algorithm or query intent-to-capability similarity matching ML model algorithm) in order to increase the confidence score to reach a threshold. This may be done while also working within the constraints of the QoS metric thresholds such that an optimum level of resources are consumed to keep the QoS metric thresholds satisfied such that the information handling system operation is not unacceptably degraded while the confidence of the output from the ML model algorithm is also met. In an embodiment, the switch between ML model algorithm execution provider hardware processors and ML model algorithm size variants may be completed within a feedback loop process in order to achieve these goals real time during user and execution of computer-readable program code instructions of the AI productivity tool software module and the AI productivity tool sub-agent described herein.

Thus, at block 332 where the ML model algorithm confidence score is not high enough to meet the ML model algorithm confidence score threshold, the method 300 may continue to block 333 to determine if the second ML model algorithm is the best ML model algorithm to produce the highest confidence score while the QoS metric threshold has not been reached. This may occur where regardless of the ML model algorithm variant (e.g., small/default or medium/large) selected to be invoked, the QoS metric threshold still cannot be met. Where, at block 333, it is not true that the second ML model algorithm that was selected produces a highest confidence score available while the QoS metric threshold still has not been reached, the method 300 may return to block 328 as described herein. This may occur in those instances where not all of the ML model algorithm variants have been tried by the hardware processor in order to satisfy the QoS metric threshold and may still meet a confidence score threshold. At block 333 where the second ML model algorithm is the best ML model algorithm to produce the highest confidence score available (which may or may not meet a confidence score threshold) while the QoS metric threshold has not been reached, the method 300 may continue to block 335 with providing a warning indicating that the QoS level for system degradation of operations are not met by the selecting among the available ML model algorithm variants. In an embodiment, this warning may be provided as a warning instruction provided to a hardware processor for the hardware processor to, for example, stop or pause the execution of some software applications (e.g., background applications and the like). In an embodiment, the warning instruction may additionally or alternatively be provided as a generated graphical user interface message to the user at the video display device indicating to the user that the information handling system may be experiencing some latency due to high computational requirements required by the operation of the AI productivity tool software module.

The method 300 may return to block 328 with the workload orchestrator switching from the previously-selected size variant ML model algorithm variant to another size variant ML model algorithm variant within the grouped plurality of ML model algorithm variants for an identified productivity-tool operation type in order to increase the confidence score. However, where, at block 332, the ML model algorithm confidence score is determined to be high enough to meet the ML model algorithm confidence score, the method 300 continues to block 320 as described herein for the responsive capability of a AI productivity tool-enablable software application to be identified as described above.

The method then proceeds to block 326, where the corresponding capability identified triggers execution of a responsive capability intent action to a received user-query input on the information handling system. For example, at block 326, the AI productivity tool software module triggers execution of computer readable code instructions of a corresponding AI productivity tool-enablable software application to conduct a software action, execution of a software driver to make hardware or firmware setting adjustments, generation of a response in text or audio, or triggers other responsive action according to embodiments herein. It is appreciated that the processes associated with blocks 312 and 332 may be completed in an iterative manner until a QoS metric is satisfied and a high enough ML model algorithm confidence score is reached for satisfying responsiveness of the AI productivity tool software module to received user-query inputs while also maintaining the QoS metric levels experienced by the user for all functions and operations on the information handling system as well.

At block 334, the method 300 includes determining if the information handling system is still initiated. Where the information handling system is still initiated, the method 300 proceeds to block 302 as described herein. Where the information handling system is no longer initiated, the method 300 may end here.

The blocks of the flow diagrams of FIG. 3 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor and a random access memory (RAM);
the hardware processor executing computer-readable program code instructions of an artificial intelligence (AI) productivity tool software module to invoke a first size-variant machine learning (ML) model algorithm selected from a plurality of available size-variant ML model algorithms to conduct an identified productivity-tool operation type, via a first ML model algorithm execution provider hardware processor, to identify a responsive capability intent action based on the user query input received at the AI productivity tool software module;
the hardware processor executing computer-readable program code instructions of a system state component discovery software application to gather runtime telemetry data describing a current consumption state of hardware components including the first ML model algorithm execution provider hardware processor and the RAM within the information handling system as the first ML model algorithm execution provider hardware processor executes the invoked first size-variant ML model algorithms; and
the hardware processor executing computer-readable program code instructions of a workload orchestrator to determine when the execution of the first size-variant ML model algorithm by the first ML model algorithm execution provider hardware processor exceeds a quality of service (QoS) metric threshold for the consumption state of the hardware components based on the gathered runtime telemetry data for the information handling system received from the system state component discovery software application and the workload orchestrator switches the first ML model algorithm execution provider hardware processor used to execute the first size-variant ML model algorithm to a second ML model algorithm execution provider hardware processor having less active processing and listed as capable to execute the first size-variant ML model algorithm for the identified productivity-tool operation type.

2. The information handling system of claim 1 wherein the first ML model algorithm execution provider hardware processor and the second ML model algorithm execution provider hardware processor are selected from a central processing unit (CPU), a neural processing unit (NPU), and a graphics processing unit (GPU), and the hardware processor executing computer-readable program code instructions of the AI productivity tool software module is the CPU at the information handling system.

3. The information handling system of claim 1 further comprising:
the plurality of available size-variant ML model algorithms for the identified productivity-tool operation type including disparate number of input parameters accepted, and processing bit sizes determining the size of each of the plurality of available size-variant ML model algorithms.

4. The information handling system of claim 1, further comprising:
the hardware processor executing computer-readable program code instructions of the system state component discovery software application to monitor the second ML model algorithm execution provider hardware processor executing the invoked first size-variant ML model algorithm to determine when the execution of the first size-variant ML model algorithm by the second ML model algorithm execution provider hardware processor exceeds the QoS metric threshold; and
the hardware processor executing computer-readable program code instructions of the workload orchestrator to switch to a second size-variant ML model algorithm from the plurality of available plurality of available size-variant ML model algorithms to execute the identified productivity-tool operation type for the AI productivity tool software module.

5. The information handling system of claim 1, wherein when the workload orchestrator determines that the execution of the first size-variant ML model algorithm by the first ML model algorithm execution provider hardware processor exceeds the QoS metric threshold, the workload orchestrator switches the first size-variant ML model algorithm selected to be executed on the second ML model algorithm execution provider hardware processor to a second size-variant ML model algorithm.

6. The information handling system of claim 1 further comprising:
the hardware processor executing computer readable program code of the workload orchestrator to determine a ML model algorithm confidence score associated with the execution of the first size-variant ML model algorithm via the second ML model algorithm execution provider hardware processor and, when the ML model algorithm confidence score does not meet a threshold ML model algorithm confidence score, the workload orchestrator switches to a second size-variant ML model algorithm among the plurality of available size-variant ML model algorithms to execute the identified productivity-tool operation type yielding the responsive capability intent action based on the user-query input.

7. The information handling system of claim 6, wherein the hardware processor executes the computer readable program code of the workload orchestrator to iteratively determine the ML model algorithm confidence score associated with the execution of each of a plurality of subsequently-selected size-variant ML model algorithms from the plurality of available size-variant ML model algorithms for the identified productivity-tool operation type until the threshold confidence score is reached or exceeded.

8. The information handling system of claim 1, wherein the first ML model algorithm execution provider hardware processor is a central processing unit (CPU) and the second ML model algorithm execution provider hardware processor is selected from a neural processing unit (NPU) and a graphics processing unit (GPU) on the information handling system.

9. A method of implementing contextual quality of service (QoS) machine learning model algorithm selection in an information handling system comprising:
executing computer-readable program code instructions via a hardware processor of an artificial intelligence (AI) productivity tool software module to invoke a first size-variant machine learning (ML) model algorithm selected from a plurality of available size-variant ML model algorithms to conduct an identified productivity-tool operation type, via a first ML model algorithm execution provider hardware processor, to identify a responsive capability intent action based on the user query input received at the AI productivity tool software module;
executing computer-readable program code instructions of a system state component discovery software application via the hardware processor to gather runtime telemetry data describing a current consumption state of hardware components including the first ML model algorithm execution provider hardware processor and a random access memory (RAM) within the information handling system as the first ML model algorithm execution provider hardware processor executes the invoked first size-variant ML model algorithms; and
executing computer-readable program code instructions of a workload orchestrator via the hardware processor to determine when the execution of the first size-variant ML model algorithm by the first ML model algorithm execution provider hardware processor exceeds a quality of service (QoS) metric threshold for the consumption state of the hardware components based on the gathered runtime telemetry data for the information handling system received from the system state component discovery software application; and
executing computer-readable program code instructions of the workload orchestrator to switch the first size-variant ML model algorithm selected to be executed on the first ML model algorithm execution provider hardware processor to a second size-variant ML model algorithm for the identified productivity-tool operation type.

10. The method of claim 9, wherein the first ML model algorithm execution provider hardware processor is selected from a central processing unit (CPU), a neural processing unit (NPU), and a graphics processing unit (GPU), and the hardware processor executing computer-readable program code instructions of the AI productivity tool software module is the CPU at the information handling system.

11. The method of claim 9 further comprising:
executing computer-readable program code instructions of the system state component discovery software application to monitor execution of the invoked second size-variant ML model algorithm to determine when the execution of the second size-variant ML model algorithm by the first ML model algorithm execution provider hardware processor exceeds the QoS metric threshold; and
executing computer-readable program code instructions of the workload orchestrator to switch to a second ML model algorithm execution provider hardware processor having less active processing than the first ML model algorithm execution provider hardware processor and listed as capable to execute the second size-variant ML model algorithm to execute the identified productivity-tool operation type for the AI productivity tool software module.

12. The method of claim 9, wherein when the workload orchestrator determines that the execution of the first size-variant ML model algorithm by the first ML model algorithm execution provider hardware processor exceeds the QoS metric threshold, the workload orchestrator switches the first ML model algorithm execution provider hardware processor to a second ML model algorithm execution provider hardware processor to execute the second size-variant ML model algorithm, wherein the second ML model algorithm execution provider hardware processor has less active processing and is listed as capable to execute the second size-variant ML model algorithm in a look-up table that defines each of the plurality of available size-variant ML model algorithms.

13. The method of claim 9 further comprising:
executing computer readable program code of the workload orchestrator by the hardware processor to determine a ML model algorithm confidence score associated with the execution of the second size-variant ML model algorithms via the first ML model algorithm execution provider hardware processor and, when the ML model algorithm confidence score does not meet a ML model algorithm threshold confidence score, the workload orchestrator switches to a third size-variant ML model algorithm among the plurality of available size-variant ML model algorithms to execute the identified productivity-tool operation type.

14. An information handling system comprising:
a hardware processor and a random access memory (RAM);
the hardware processor executing computer-readable program code instructions of an artificial intelligence (AI) productivity tool software module to invoke a first size-variant machine learning (ML) model algorithm selected from a plurality of available size-variant ML model algorithms to conduct an identified productivity-tool operation type, via a first ML model algorithm execution provider hardware processor, to identify a responsive capability intent action based on the user query input received at the AI productivity tool software module;
the hardware processor executing computer-readable program code instructions of a system state component discovery software application to gather runtime telemetry data describing a current consumption state of hardware components including the first ML model algorithm execution provider hardware processor and the RAM within the information handling system as the first ML model algorithm execution provider hardware processor executes the invoked first size-variant ML model algorithms; and
the hardware processor executing computer-readable program code instructions of a workload orchestrator determines when the execution of the first size-variant ML model algorithm by the first ML model algorithm execution provider hardware processor exceeds a quality of service (QoS) metric threshold for the consumption state of the hardware components based on the gathered runtime telemetry data for the information handling system received from the system state component discovery software application, and the workload orchestrator switches the first size-variant ML model algorithm selected to be executed on the first ML model algorithm execution provider hardware processor to a second size-variant ML model algorithm for the identified productivity-tool operation type.

15. The information handling system of claim 14, wherein the first ML model algorithm execution provider hardware processor is selected from a central processing unit (CPU), a neural processing unit (NPU), and a graphics processing unit (GPU), and the hardware processor executing computer-readable program code instructions of the AI productivity tool software module is the CPU at the information handling system.

16. The information handling system of claim 14 further comprising:
the plurality of available size-variant ML model algorithms for the identified productivity-tool operation type includes disparate number of input parameters accepted, and processing bit sizes that determine the size of each of the plurality of available size-variant ML model algorithms.

17. The information handling system of claim 14, further comprising:
the hardware processor executing computer-readable program code instructions of the system state component discovery software application to monitor executing the invoked second size-variant ML model algorithm to determine when the execution of the second size-variant ML model algorithm by the first ML model algorithm execution provider hardware processor exceeds the QoS metric threshold; and
the hardware processor executing computer-readable program code instructions of the workload orchestrator to switch to a second ML model algorithm execution provider hardware processor having less active processing than the first ML model algorithm execution provider hardware processor and listed as capable to execute the second size-variant ML model algorithm to execute the identified productivity-tool operation type for the AI productivity tool software module.

18. The information handling system of claim 14, wherein when the workload orchestrator determines that the execution of the first size-variant ML model algorithm by the first ML model algorithm execution provider hardware processor exceeds the QoS metric threshold, the workload orchestrator switches the first ML model algorithm execution provider hardware processor to a second ML model algorithm execution provider hardware processor to execute the second size-variant ML model algorithm, wherein the second ML model algorithm execution provider hardware processor has less active processing and is listed as capable to execute the second size-variant ML model algorithm in a look-up table that defines each of the plurality of available size-variant ML model algorithms.

19. The information handling system of claim 14 further comprising:
the hardware processor executing computer readable program code of the workload orchestrator to determine a ML model algorithm confidence score associated with the execution of the first size-variant ML model algorithm via the first ML model algorithm execution provider hardware processor and, when the ML model algorithm confidence score does not meet a threshold ML model algorithm confidence score, the workload orchestrator switches to the second size-variant ML model algorithm among the plurality of available size-variant ML model algorithms to execute the identified productivity-tool operation type yielding the responsive capability intent action based on the user-query input.

20. The information handling system of claim 14 further comprising:
the hardware processor executing computer readable program code of the workload orchestrator to determine a ML model algorithm confidence score associated with the execution of the first size-variant ML model algorithm via the first ML model algorithm execution provider hardware processor and the workload orchestrator to iteratively determine the ML model algorithm confidence score associated with the execution of each of a plurality of subsequently-selected size-variant ML model algorithms from the plurality of available size-variant ML model algorithms for the identified productivity-tool operation type until the ML model algorithm threshold confidence score is reached or exceeded.
